(19) United States
(12) Patent Application Publication
(10) Pub. No.: US 2025/0212155 A1
(43) Pub. Date: Jun. 26, 2025

(54) POSITIONING MEASUREMENT BASED SECRET KEY SHARING BETWEEN NETWORK ENTITIES

(71) Applicant: QUALCOMM Incorporated, San Diego, CA (US)

(72) Inventors: Alexandros MANOLAKOS, Athens (GR); Ahmed ELSHAFIE, San Diego, CA (US)

(21) Appl. No.: 18/847,637

(22) PCT Filed: Apr. 6, 2023
(86) PCT No.: PCT/US2023/017793

§ 371 Date: Sep. 16, 2024

(30) Foreign Application Priority Data
May 23, 2022 (GR) 20220100428

(51) Int. Cl. H04W 64/00; H04L 5/00; H04W 12/041; H04W 12/0431

(52) U.S. Cl. CPC H04W 64/00; H04L 5/0051; H04W 12/041; H04W 12/0431

(57) ABSTRACT

Aspects presented herein provide an improved secret key sharing scheme based on positioning measurements, where a pair of network devices may extract an SK from a channel associated with positioning and use the SK to secure some unsecured channels and to further improve the security of other channels such as PDSCH and PUSCH from PHY security respective. In one aspect, a UE performs one or more positioning measurements based on a set of signals from at least one network node, where the one or more positioning measurements are associated with at least one of a location of the UE or a location of the at least one network node. The UE selects a secret key for communication with the at least one network node based on the one or more positioning measurements. The UE communicates with the at least one network node based on the secret key.

### CROSS-REFERENCE TO RELATED APPLICATIONS

This application claims the benefit of Greek application No. 20220100428, entitled “POSITIONING MEASUREMENT BASED SECRET KEY SHARING BETWEEN NETWORK ENTITIES” and filed on May 23, 2022, which is expressly incorporated by reference herein in its entirety.

### TECHNICAL FIELD

The present disclosure relates generally to communication systems, and more particularly, to communication systems involving communication security.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus performs one or more positioning measurements based on a set of signals from at least one network node, where the one or more positioning measurements are associated with at least one of a location of the user equipment (UE) or a location of the at least one network node. The apparatus selects a secret key for communication with the at least one network node based on the one or more positioning measurements. The apparatus communicates with the at least one network node based on the secret key.

In an aspect of the disclosure, a method, a computer-readable medium, and an apparatus are provided. The apparatus receives one or more positioning measurements based on a set of signals from at least one network node, where the one or more positioning measurements are associated with at least one of a location of a UE or a location of the at least one network node. The apparatus selects a secret key for communication of the at least one network node based on the one or more positioning measurements. The apparatus transmits an indication of the secret key to the at least one network node.

In an aspect of the disclosure, a method, a computer-readable medium, and an apparatus are provided. The apparatus configures at least one parameter for transmitting a set of signals. The apparatus selects a secret key for communication with a second network node based on the at least one parameter. The apparatus transmits the set of signals to the second network node based on the at least one parameter and the secret key.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5A is a diagram illustrating an example downlink-positioning reference signal (DL-PRS) resource pattern in accordance with various aspects of the present disclosure.

FIG. 5B is a diagram illustrating an example DL-PRS resource pattern in accordance with various aspects of the present disclosure.

FIG. 5C is a diagram illustrating an example DL-PRS resource pattern in accordance with various aspects of the present disclosure.

FIG. 5D is a diagram illustrating an example DL-PRS resource pattern in accordance with various aspects of the present disclosure.

FIG. 5E is a diagram illustrating an example DL-PRS resource pattern in accordance with various aspects of the present disclosure.

FIG. 5F is a diagram illustrating an example DL-PRS resource pattern in accordance with various aspects of the present disclosure.

FIG. 5G is a diagram illustrating an example DL-PRS resource pattern in accordance with various aspects of the present disclosure.

FIG. 5H is a diagram illustrating an example DL-PRS resource pattern in accordance with various aspects of the present disclosure.

FIG. 6 is a diagram illustrating an example scenario in which a communication between a base station and a UE may be tampered by another UE in accordance with various aspects of the present disclosure.

FIG. 7 is a communication flow illustrating an example secret-key extraction from channel randomness in accordance with various aspects of the present disclosure.

FIG. 8 is a communication flow illustrating an example secret-key extraction based on positioning measurements in accordance with various aspects of the present disclosure.

FIG. 9 is a diagram illustrating an example scenario of a potential eavesdropper/attacker in proximity to a UE generating the same secret key (SK) as the UE in accordance with various aspect of the present disclosure.

FIG. 10 is a diagram illustrating an example of a base station modifying positioning measurements or uncertainties associated with the positioning measurements based on the quality metric provided by a UE in accordance with various aspects of the present disclosure.

FIG. 11 is a flowchart of a method of wireless communication.

FIG. 12 is a flowchart of a method of wireless communication.

FIG. 13 is a diagram illustrating an example of a hardware implementation for an example apparatus and/or network entity.

FIG. 14 is a flowchart of a method of wireless communication.

FIG. 15 is a flowchart of a method of wireless communication.

FIG. 16 is a diagram illustrating an example of a hardware implementation for an example apparatus and/or network entity.

FIG. 17 is a flowchart of a method of wireless communication.

FIG. 18 is a diagram illustrating an example of a hardware implementation for an example apparatus and/or network entity.

FIG. 19 is a diagram illustrating an example of a hardware implementation for an example apparatus and/or network entity.

### DETAILED DESCRIPTION

Aspects presented herein may improve the security and integrity of wireless communication. Aspects presented herein provide a new type of secret-key (SK) sharing scheme based on positioning measurements, where a pair of network devices/entities may be configured to extract an SK from a channel associated with positioning and use the SK to secure some unsecured channels (e.g., PUCCH, DCI, etc.) and/or to further improve the security of other channels such as PDSCH and PUSCH from PHY security respective.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit.

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

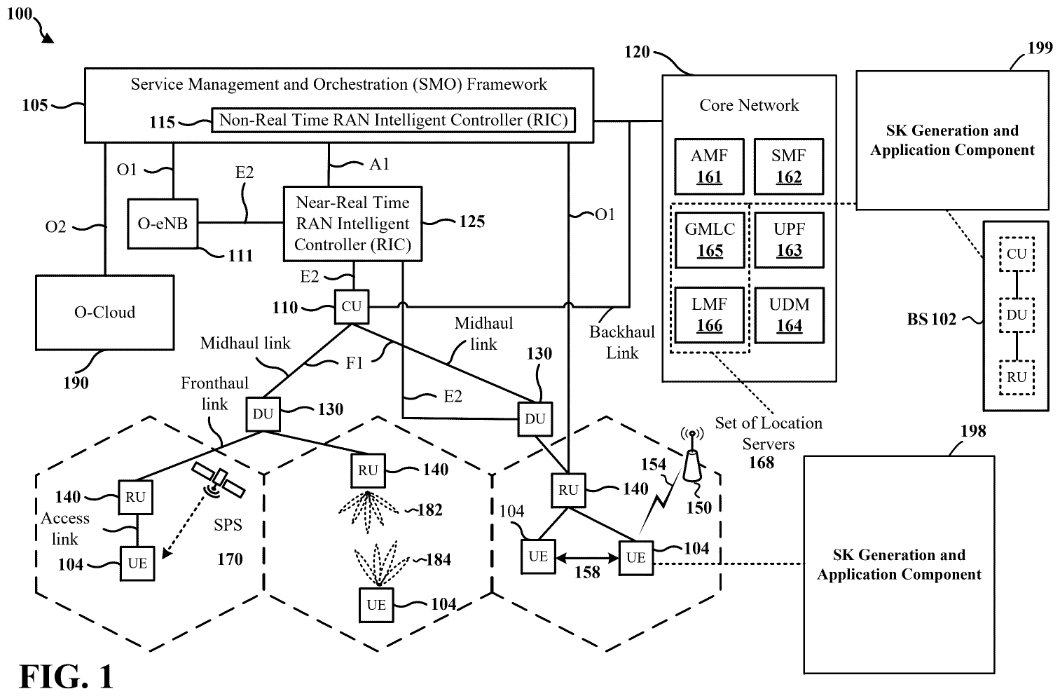

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RA configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to perform one or more positioning measurements based on a set of signals from at least one network node, where the one or more positioning measurements are associated with at least one of a location of the UE or a location of the at least one network node; select a secret key for communication with the at least one network node based on the one or more positioning measurements; and communicate with the at least one network node based on the secret key via the SK generation and application component 198. In certain aspects, the one or more location servers 168 may be configured to receive one or more positioning measurements based on a set of signals from at least one network node, where the one or more positioning measurements are associated with at least one of a location of a UE or a location of the at least one network node; select a secret key for communication of the at least one network node based on the one or more positioning measurements; and transmit an indication of the secret key to the at least one network node via the SK generation and application component 199. In certain aspects, the UE 104 and/or the base station 102 may be configured to configure at least one parameter for transmitting a set of signals, select a secret key for communication with a second network node based on the at least one parameter, and transmit the set of signals to the second network node based on the at least one parameter and the secret key via the SK generation and application component 198/199.

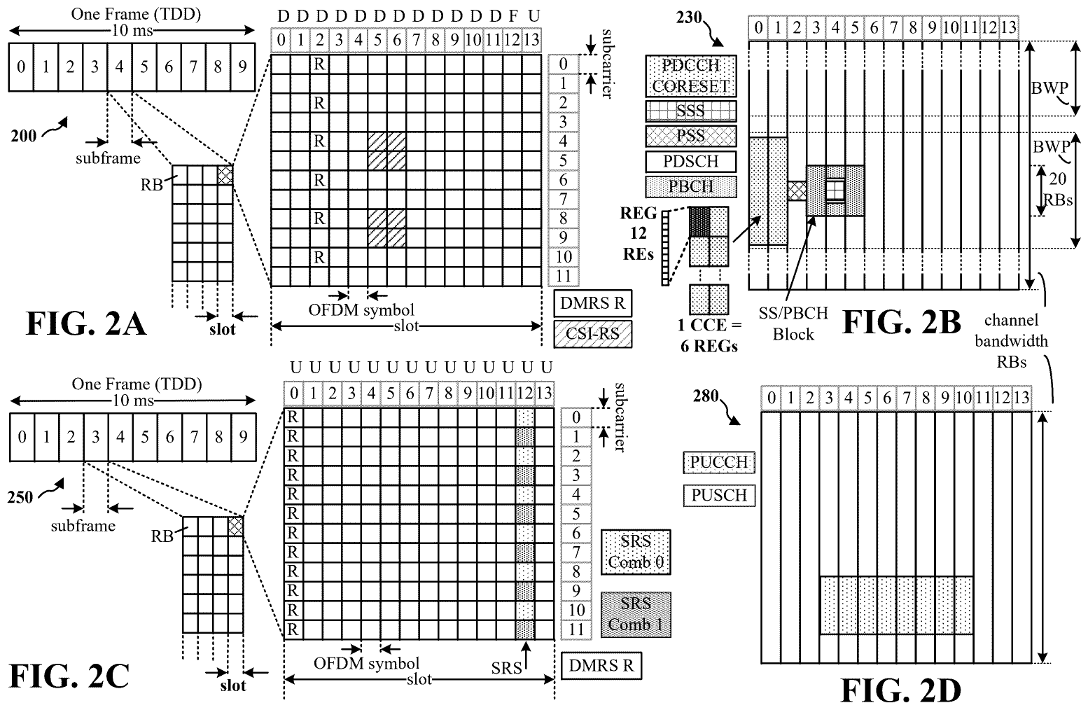

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2″ slots/subframe. The subcarrier spacing may be equal to 2^{μ} *15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

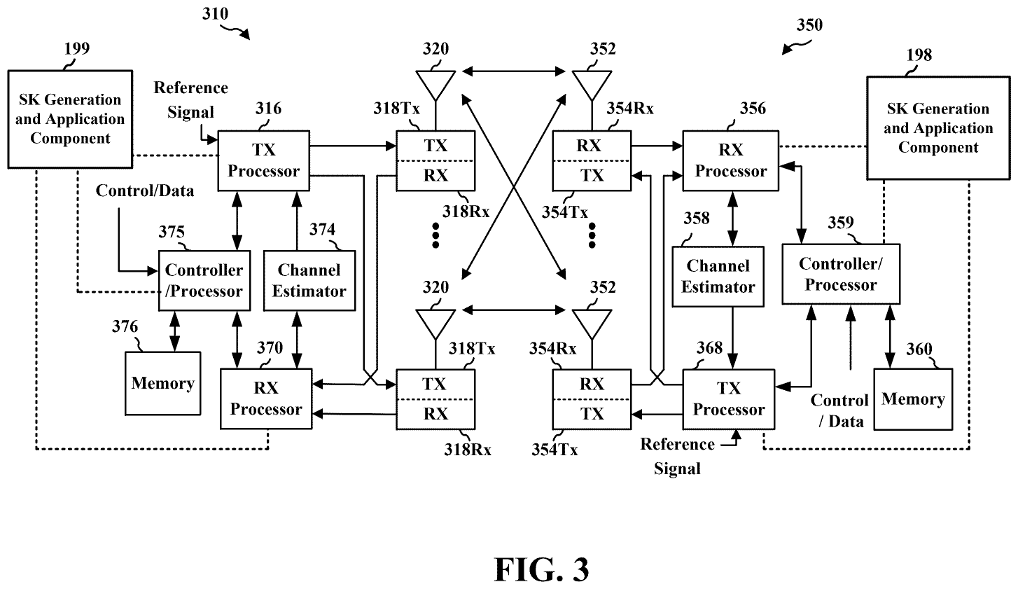

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality. The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the sensing signal process component 198 of FIG. 1.

At least one of the TX processor 316, the RX processor 370, and the controller/processor 375 may be configured to perform aspects in connection with the SK generation and application component 199 of FIG. 1.

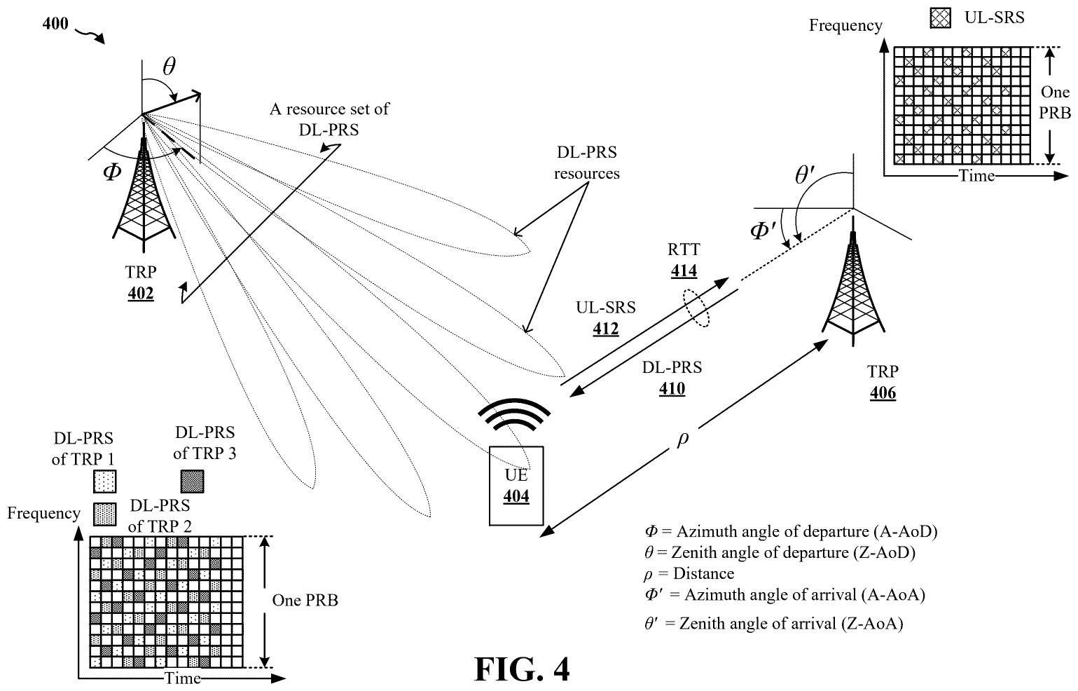

FIG. 4 is a diagram 400 illustrating an example of a UE positioning based on reference signal measurements (which may also be referred to as “network-based positioning”) in accordance with various aspects of the present disclosure. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on |T_{SRS_RX}-T_{PRS_TX}−|T_{SRS_TX}−T_{PRS_RX}|. Accordingly, multi-RTT positioning may make use of the UE Rx-Tx time difference measurements (i.e., |T_{SRS_TX}-T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}-T_{PRS_TX}|) and UL-SRS-RSRP at multiple TRPs 402, 406 of uplink signals transmitted from UE 404. The UE 404 measures the UE Rx-Tx time difference measurements (and/or DL-PRS-RSRP of the received signals) using assistance data received from the positioning server, and the TRPs 402, 406 measure the gNB Rx-Tx time difference measurements (and/or UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL-PRS-RSRP) of downlink signals received from multiple TRPs 402, 406 at the UE 404. The UE 404 measures the DL RSTD (and/or DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL-SRS-RSRP) at multiple TRPs 402, 406 of uplink signals transmitted from UE 404. The TRPs 402, 406 measure the UL-RTOA (and/or UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. If needed to further distinguish the type of PRS, a downlink positioning reference signal may be referred to as a “DL-PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

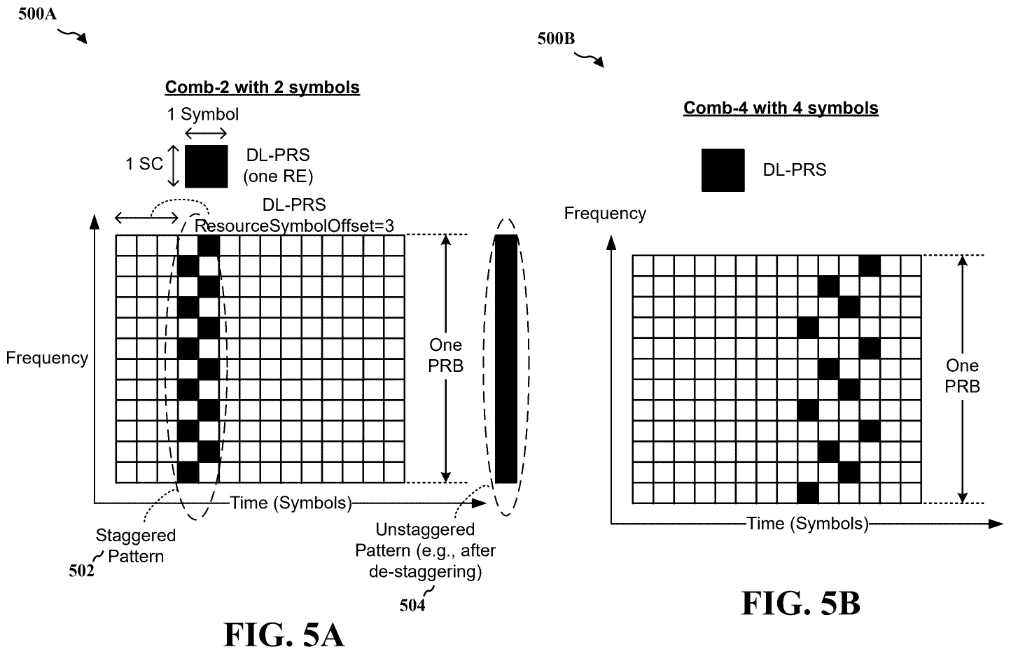

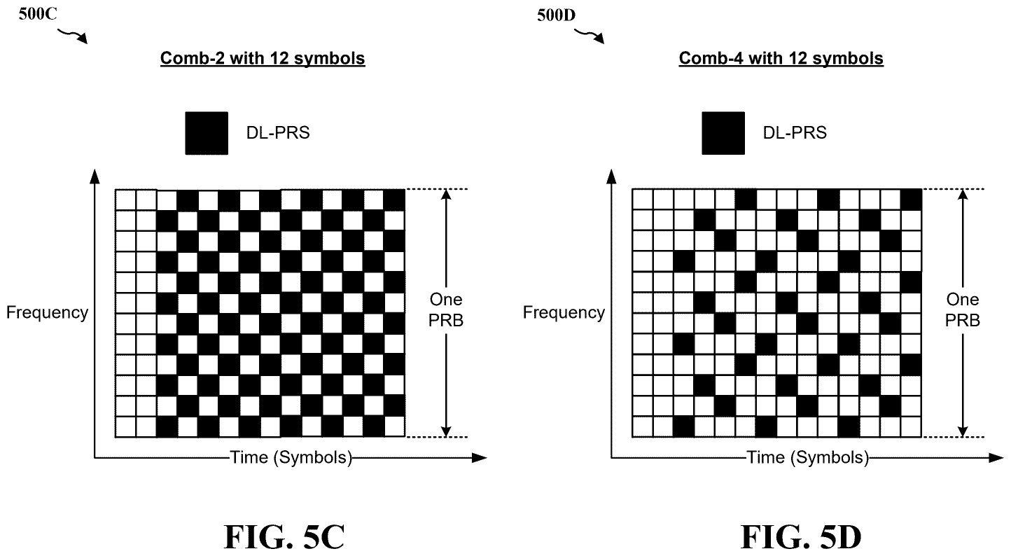

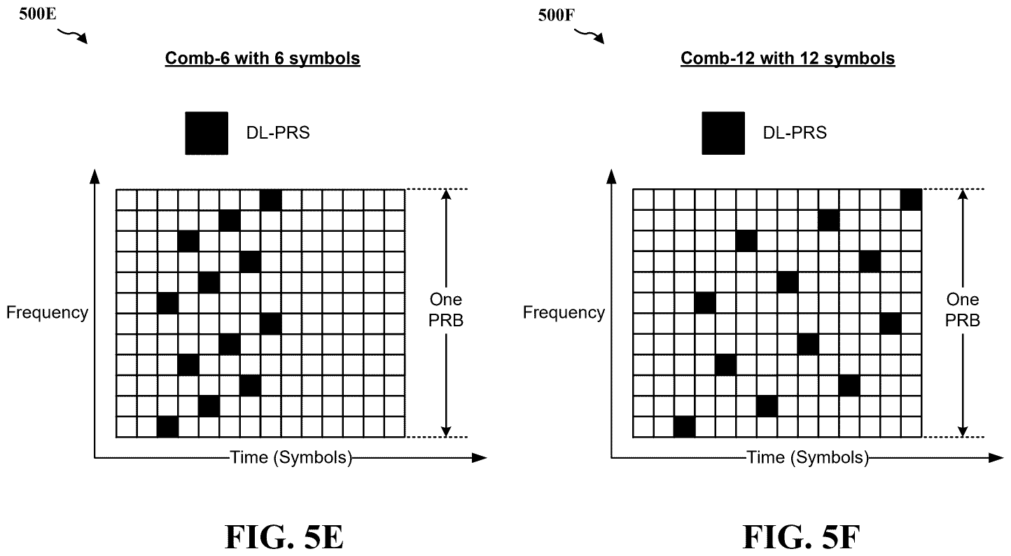

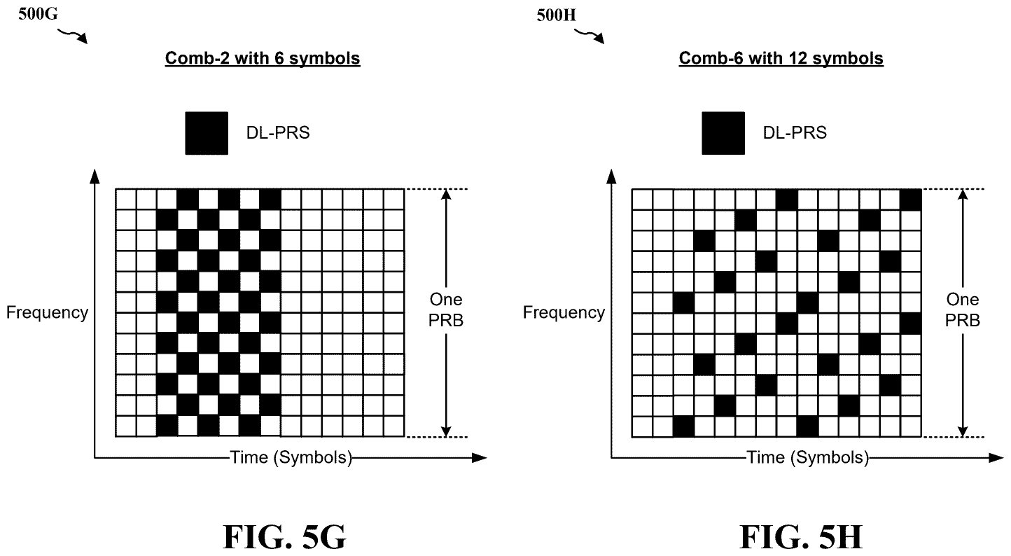

FIGS. 5A to 5H are diagrams 500A to 500H, respectively, illustrating example patterns of DL-PRS resource within a slot in accordance with various aspect of the present disclosure. A DL-PRS resource may spans within a slot 2, 4, 6, or 12 consecutive symbols with a fully frequency-domain staggered pattern. The DL-PRS resource may be configured in a high layer configured DL or FL symbol of a slot. In addition, all REs of a given DL-PRS resource may have a constant energy per resource element (EPRE).

The patterns illustrated by the diagrams 500A to 500H may be referred to as “staggered pattern” or a “frequency-domain staggered pattern,” where the resource elements on which the DL-PRS are transmitted may be staggered in the frequency domain of a given bandwidth such that these resource elements are not adjacent to each other in two consecutive resource elements on the given bandwidth. In addition, while the resource elements on which the DL-PRS are transmitted may be staggered over multiple symbols, the resource elements may occupy the whole bandwidth if they are de-staggered. For example, diagram 500A of FIG. 5A illustrates an example DL-PRS resource based on a comb-2 with 2 symbols pattern, where there is one PRS resource element per every two subcarriers in the frequency domain for two occupying symbols, such as shown at 502. In addition, a set of frequency offsets may be applied to the PRS resource elements in each of the occupying symbols. For example, a frequency offset of {0, 1} may be applied to the comb-2 with 2 symbols pattern, where PRS resource elements on the first occupying symbol may be transmitted with an offset of zero (0) and PRS resource elements on the second occupying symbol may be transmitted with an offset of one (1). As such, the PRS resource elements may also not be adjacent to each other on the time domain. As shown at 504, while the PRS resource elements may be staggered in a given bandwidth (and also on a given time domain), after a UE receives these PRS resource elements, the UE may still able to receive the full bandwidth of the PRS, which may be referred to as de-staggering a staggered pattern or turning a staggered pattern to an unstaggered pattern.

Similarly, diagram 500B of FIG. 5B illustrates an example DL-PRS resource based on a comb-4 with 4 symbols pattern, where there is one PRS resource element per every four subcarriers in the frequency domain for four occupying symbols and the pattern may include a frequency offset of {0, 2, 1, 3}. Diagram 500C of FIG. 5C illustrates an example DL-PRS resource based on a comb-2 with 12 symbols pattern, where there is one PRS resource element per every two subcarriers in the frequency domain for twelve occupying symbols and the pattern may include a frequency offset of {0, 1, 0, 1, 0, 1, 0, 1, 0, 1, 0, 1}. Diagram 500D of FIG. 5D illustrates an example DL-PRS resource based on a comb-4 with 12 symbols pattern, where there is one PRS resource element per every four subcarriers in the frequency domain for twelve occupying symbols and the pattern may include a frequency offset of {0, 2, 1, 3, 0, 2, 1, 3, 0, 2, 1, 3}. Diagram 500E of FIG. 5E illustrates an example DL-PRS resource based on a comb-6 with 6 symbols pattern, where there is one PRS resource element per every six subcarriers in the frequency domain for six occupying symbols and the pattern may include a frequency offset of {0, 3, 1, 4, 2, 5}. Diagram 500F of FIG. 5F illustrates an example DL-PRS resource based on a comb-12 with 12 symbols pattern, where there is one PRS resource element per every twelve subcarriers in the frequency domain for twelve occupying symbols and the pattern may include a frequency offset of {0, 6, 3, 9, 1, 7, 4, 10, 2, 8, 5, 11}. Diagram 500G of FIG. 5G illustrates an example DL-PRS resource based on a comb-2 with 6 symbols pattern, where there is one PRS resource element per every two subcarriers in the frequency domain for six occupying symbols and the pattern may include a frequency offset of {0, 1, 0, 1, 0, 1}. Diagram 500H of FIG. 5H illustrates an example DL-PRS resource based on a comb-6 with 12 symbols pattern, where there is one PRS resource element per every six subcarriers in the frequency domain for twelve occupying symbols and the pattern may include a frequency offset of {0, 3, 1, 4, 2, 5, 0, 3, 1, 4, 2, 5}.

In some scenarios, azimuth angle of arrival (AoA)(ϕ) and zenith angle of arrival (ZoA)(θ) may be used to define the estimated angles of a UE with respect to a reference direction which are determined at a TRP antenna for an UL channel corresponding to this UE. The reference directions may be defined based on Global Coordinate System (GCS) and/or Local Coordinate System (LCS). The estimated angles may also be referred to as angular measurements, which may be reported by a UE and/or a base station based on a defined granularity. For example, the reporting granularity for base station angle measurements (e.g., AoA, ZoA) may be defined as 0.1 degree. Similarly, the reporting granularity for a set of angles α (bearing angle), β (downtilt angle) and y (slant angle) for the translation of the GCS to LCS may also be defined as 0.1 degree.

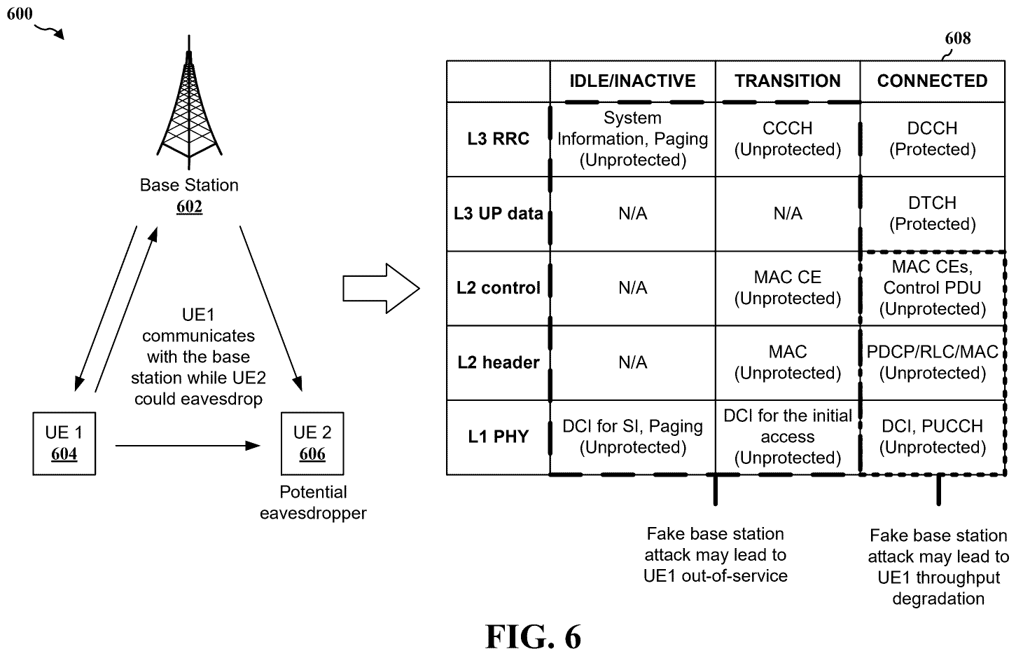

FIG. 6 is a diagram 600 illustrating an example scenarios in which a communication between a base station and a UE may be tampered by another UE in accordance with various aspects of the present disclosure. A base station 602 may be communicating with a first UE 604, and the communication between them may be eavesdropped by a second UE 606, which may be a malicious device that is capable of generating attacks to the communication between the base station 602 and the first UE 604. For example, the second UE 606 may generate fake signals identical to the base station 602 and transmit the fake signals to the first UE 604 to interfere the communication and/or the positioning of the first UE 604, which may be referred to as fake base station attack hereafter.

As shown by the table at 608, when the first UE 604 is in an idle/inactive mode or is transitioning to a connected mode, fake base station attacks may lead the first UE 604 to be out-of-service. If the first UE 604 is in a connected mode, fake base station attacks may lead to throughput degradation at the first UE 604. As such, securing communications may be very important and crucial for wireless communications systems, such as for wireless communications that include many devices connected to each other (e.g., IoT). Given the level of power of such devices, enhancing the security (e.g., physical layer (PHY) security) with additional secure bits obtained from channels and sounding signals between the legit nodes (e.g., legit network entity such as the base station 602 and the first UE 604) are likely to be beneficial. Aspects presented herein may improve the security and integrity of wireless communication. Aspects presented herein provide a new type of secret-key (SK) sharing scheme based on positioning measurements, where a pair of network devices/entities may be configured to extract an SK from a channel associated with positioning and use the SK to secure some unsecured channels (e.g., PUCCH, DCI, etc.) and/or to further improve the security of other channels such as PDSCH and PUSCH from PHY security respective.

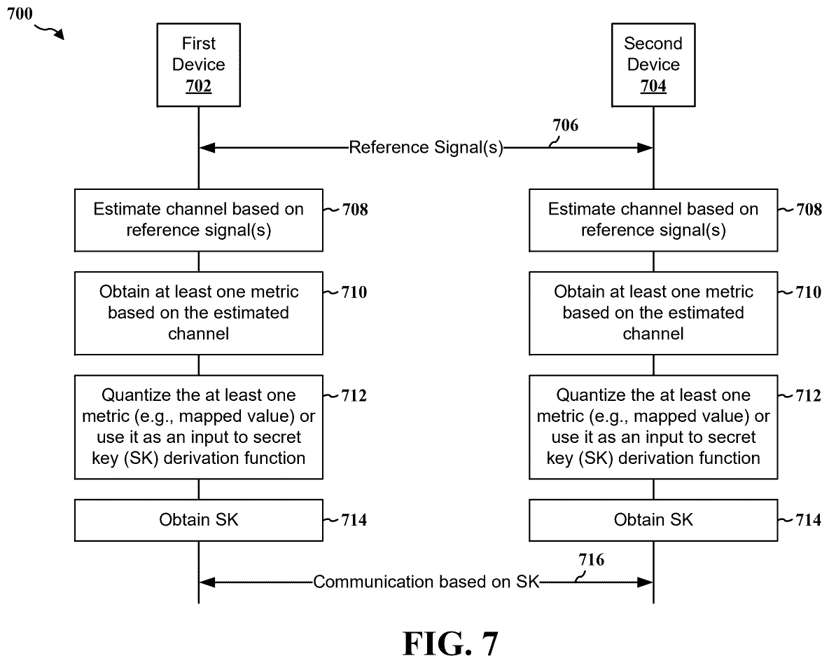

FIG. 7 is a communication flow 700 illustrating an example secret-key extraction from channel randomness in accordance with various aspects of the present disclosure. The numberings associated with the communication flow 700 do not specify a particular temporal order and are merely used as references for the communication flow 700. Aspects presented herein may enable two network nodes, such as base station(s), base station component(s), UEs, sidelink device(s), or a combination thereof, to derive SK based on channel estimation, and to communicate with each other based on the derived SK.

At 706, a first device 702 (e.g., a first base station, a component of the first base station, a first UE, or a first sidelink device, etc.) and a second device 704 (e.g., a second base station, a component of the second base station, a second UE, or a second sidelink device, etc.) may exchange reference signals with each other.

At 708, the first device 702 and the second device 704 may each perform channel estimation based on reference signals received from each other. For example, the second device 704 may transmit a set of reference signals to the first device 702, and the first device 702 may estimate the channel by measuring the set of reference signals.

At 710, the first device 702 and the second device 704 may obtain at least one metric based on the channel estimation. For example, the at least one metric may include the channel power, the RSRP of the channel, the signal-to-interference-plus-noise ratio (SINR) of the channel, and/or the phase of the channel, etc.

At 712, the first device 702 and the second device 704 may quantize the at least one metric (or one or more mapped values) or use the at least one metric as an input to a secret key derivation function (e.g., HMAC-SHA-256 (Key, [other parameters]). For purposes of the present disclosure, a secret key may refer to a piece of information or parameter that may be used to encrypt and decrypt messages in a symmetric, or secret-key, encryption.

At 714, the first device 702 and the second device 704 may both obtain the SK. In some examples, if the SNR of the channel is above a threshold (e.g., at high SNR), the SK obtained may be quite secured. However, if the SNR of the channel is not above the threshold (e.g., at low SNR), some repetition of pilot signal(s) and/or key refinement procedure(s) may be implemented by the first device 702 and the second device 704.

At 716, the first device 702 and the second device 704 may use the SK to secure the transmissions between the first device 702 and the second device 704. For example, the first device 702 and the second device 704 may use the SK to secure (e.g., encode/decode or encrypt/decrypt) some fields within a PHY channel, such as some information in control channel, shared channel, and/or sidelink channel (e.g., some information in PDCCH, PUCCH, PDSCH, and/or PUSCH). If a communication is unable to be decoded/decrypt based on the SK, the first device 702 or the second device 704 may be configured to discard the communication. As such, communication between the first device 702 and the second device 704 may be secured based on the SK to prevent malicious attacks from another device.

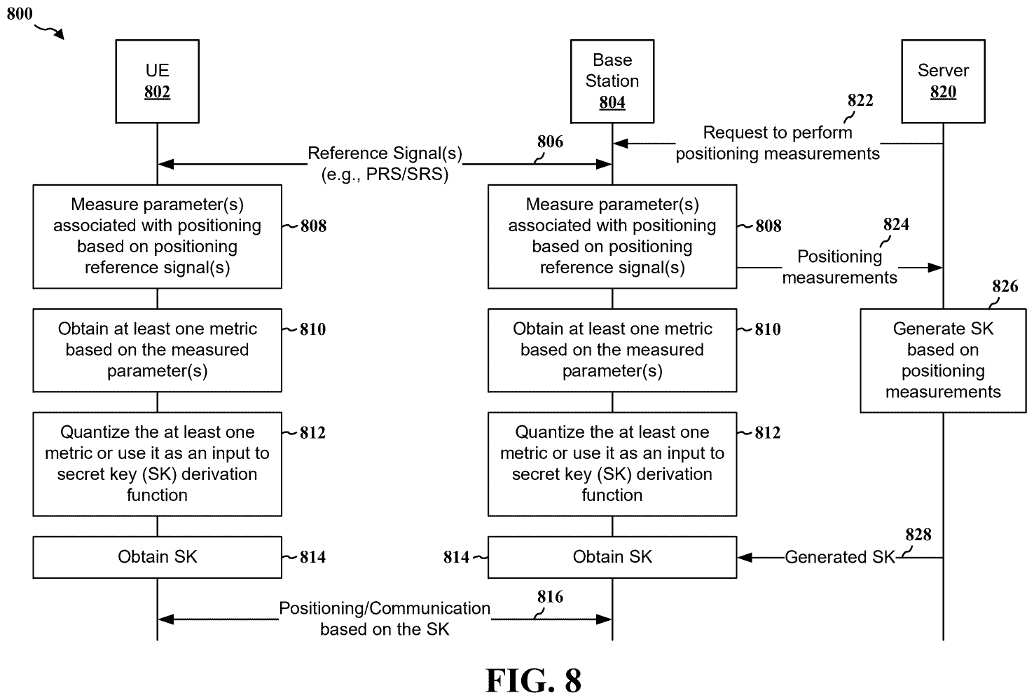

FIG. 8 is a communication flow 800 illustrating an example secret-key extraction based on positioning measurements in accordance with various aspects of the present disclosure. The numberings associated with the communication flow 800 do not specify a particular temporal order and are merely used as references for the communication flow 800. Aspects presented herein may enable a UE and a base station or a component of the base station (e.g., a TRP) to derive SK based on parameter(s) associated with positioning measurements during a UE positioning session, such that the UE and the base station may perform the UE positioning session with the derived SK to improve the security and integrity of the UE positioning session. While aspects illustrated herein are based on a positioning session between a UE and a base station, aspects presented herein may also apply to sidelink positioning, such as between two sidelink devices (e.g., two UEs, a UE and an RSU, etc.).

At 806, a UE 802 and a base station 804 (or a component of the base station 804) may establish a UE positioning session, such as described in connection with FIG. 4. Then, the UE 802 and the base station 804 may exchange reference signals with each other. For example, the base station 804 may transmit one or more PRSs to the UE 802 (e.g., via one or more antenna panels or TRPs), and the UE 802 may transmit one or more SRSs to the base station 804. In other examples, the reference signals may include synchronization signal blocks (SSBs), channel state information-reference signals (CSI-RSs), demodulation reference signals (DMRSs), sidelink reference signals, or a combination thereof.

At 808, the UE 802 and the base station 804 may each measure parameter(s) associated with the UE positioning session based on the reference signals received (hereafter “positioning measurements”). For example, the UE 802 and the base station 804 may measure the RSRP, the path RSRP (PRSRP), the RSTD, the phase path, the relative time of arrival (RToA), the AoA, the ZoA, the SINR, one or more quality metrics, the Doppler shift, and/or the reception-transmission (Rx-Tx) time difference for the reference signals received, such as described in connection with FIG. 4. Quality metric(s) may refer to the performance associated with the positioning measurements. For example, quality metric(s) may include the uncertainty, accuracy/precision, coverage, latency, and/or errors associated with positioning measurements.

At 810, the UE 802 and the base station 804 may obtain at least one metric based on the positioning measurements. For example, the at least one metric may include the RSRP, the PRSRP, the RSTD, the phase path, the RToA, the AoA, the ZoA, the SINR, one or more quality metrics, the Doppler shift, the Rx-Tx time difference, or a combination thereof.

At 812, the UE 802 and the base station 804 may quantize the at least one metric (or one or more mapped values) and/or use the at least one metric as an input to a secret key derivation function (e.g., HMAC-SHA-256 (Key, [other parameters]). For example, the UE 802 may use multiple times of arrival (ToAs) obtained from the PRSs transmitted from the base station 804 to derive the SK, e.g., the UE 802 measures ToAs across a few base stations (e.g., including the base station 804) or TRPs of a base station, and the UE 802 derives an RSTD vector (e.g., RSTDs with multiple base stations/TRPs) based on the measured ToAs. The derived RSTD vector is likely to be a unique fingerprinting for the UE 802 that is suitable for generating the SK. As such, the UE 802 may derive the SK using the RSTD vector as an input and/or as a secure random number generator (e.g., cryptographically secure PRNG) initialization, e.g., as an input to a secret key derivation function such as HMAC-SHA-256 (e.g., Key, [other parameters]). Similarly, the base station 804 may use multiple ToAs obtained from the SRSs transmitted from the UE 802 to derive an SK, e.g., the base station 804 measures ToAs for SRSs received from the UE 802 and derives an RSTD vector (which may be referred to as an RToA vector for UL). As such, the base station 804 may derive the SK using the RToA vector as an input and/or as a secure random number generator (e.g., cryptographically secure PRNG) initialization, e.g., as an input to a secret key derivation function such as HMAC-SHA-256 (e.g., Key, [other parameters]).

At 814, the UE 802 and the base station 804 may both generate the SK based on the at least one metric and the secret key derivation function. As the at least one metric obtained by the UE 802 and the base station 804 may be based on a one-to-one mapping associated with the physical location of the UE 802, both the RSTD vector derived by the UE 802 and the RToA vector derived by the base station 804 may result in the same SK.

In some examples, if the SNR of the channel is above a threshold (e.g., at high SNR), the SK obtained may be quite secured. However, if the SNR of the channel is not above the threshold (e.g., at low SNR), some repetition of pilot signal(s) and/or key refinement procedure(s) may be implemented by the UE 802 and the base station 804.

At 816, the UE 802 and the base station 804 may perform the UE positioning session based on the SK generated to secure the transmissions between the UE 802 and the base station 804. For example, the UE 802 may use the SK to encode/encrypt SRS to be transmitted to the base station 804 and to decode/decrypt the PRS received from the base station 804. Similarly, the base station 804 may use the SK to encode/encrypt PRS to be transmitted to the UE 802 and to decode/decrypt the SRS received from the UE 802. In another example, the UE 802 and/or the base station 804 may also use the SK to secure some fields within a PHY channel, such as some information in control channel, shared channel, and/or sidelink channel (e.g., some information in PDCCH, PUCCH, PDSCH, and/or PUSCH). In other words, the SK derived by the UE 802 and the base station 804 may also be used for communication purposes. If the UE 802 or the base station 804 is unable to decode/decrypt the positioning reference signals (e.g., PRS and SRS) or the communication received, the UE 802 or the base station 804 may exclude positioning measurements associated with the positioning reference signals or the communications. As such, positioning and/or communication between the UE 802 and the base station 804 may be secured based on the SK to prevent malicious attacks from another device.

In some examples, the SK generation process for the UE 802 and/or the base station 804 may be configured or performed by a server (e.g., a location server, a location management function (LMF), etc.). For example, as shown at 822, a server 820 may send a request to the base station 804 (and other base stations/sidelink devices) to perform positioning measurements for the UE 802 (e.g., for the UE positioning session). At 824, the server 820 may receive the positioning measurements from the base station 804 (and other base stations). At 826, the server 820 may generate an SK based on the positioning measurements received from base stations (e.g., pushing the positioning measurements through a secret key generator). At 828, the server 820 may transmit the generated SK to the base station 804 (and other base stations). Then, the base station 804 may perform the UE positioning or communication with the UE 802 based on the SK, such as described in connection with 816.

In some scenarios, while generating SK based on positioning measurements may improve the security and integrity of the positioning and/or the communication between a UE and one or more base stations/TRPs, there is a chance that a potential eavesdropper/attacker (e.g., the second UE 606) may also be able to generate the same SK if the potential eavesdropper/attacker is in proximity to the UE and is aware of the SK generation procedure/algorithm used by the UE and the one or more base stations/TRPs.

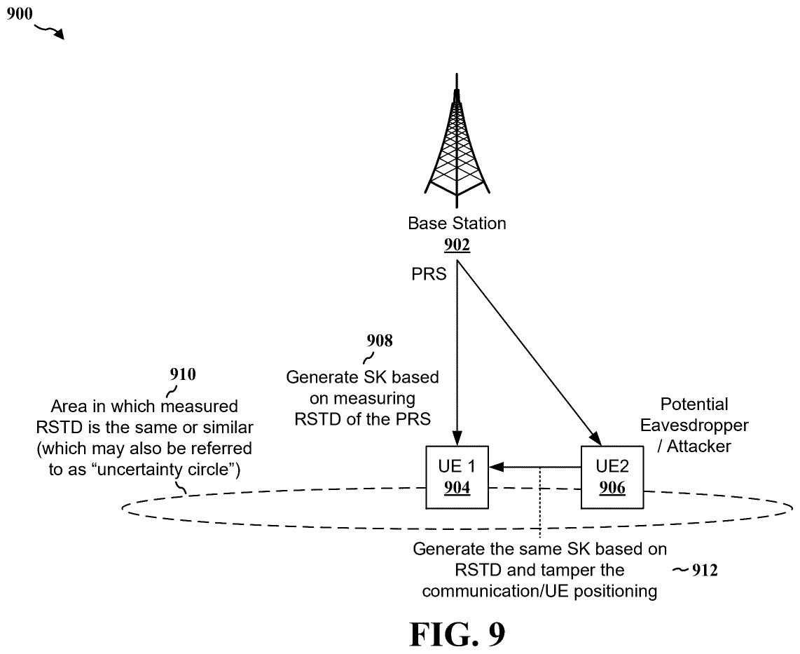

FIG. 9 is a diagram 900 illustrating an example scenario of a potential eavesdropper/attacker in proximity to a UE generating the same SK as the UE in accordance with various aspect of the present disclosure. As shown at 908, a first UE 904 may be communicating and/or performing UE positioning with a base station 902, and the UE 904 may generate an SK for the communication and/or the UE positioning based on the RSTD vector (e.g., obtained from measuring the SRS transmitted from the base station 902) as described in connection with FIG. 8. As the RSTD vector may be a unique fingerprint between the first UE 904 and the base station 902, SK generated based on the RSTD vector may be used for securing the communication and/or the UE positioning between the first UE 904 and the base station 902.

However, as shown at 910, the RSTD measured by the first UE 904 may be the same or similar within an area, such as within X meters of the first UE 904. As such, if a second UE 906, which may be a potential eavesdropper/attacker, is in proximity to the first UE 904 (e.g., within X meters of the first UE 904), the RSTD measured by the second UE 906 (e.g., also obtained from measuring the SRS transmitted from the base station 902) may be the same or similar to the RSTD measured by the first UE 904. As shown at 912, if the second UE 906 is aware of the algorithm used by the first UE 904 and the base station 902 for generating the SK (e.g., based on the RSTD vector), the second UE 906 may be able to generate the same SK as the first UE 904 and tamper the communication and/or the UE positioning between the first UE 904 and the base station 902 (e.g., generate the fake base station attacks).

As such, in another aspect of the present disclosure, instead of generating the SK based on one type of positioning measurement, UEs/base stations may be configured to generate the SK based on a combination of different positioning measurements to further enhance the security/integrity level. In other words, instead of generating the SK based on one type of positioning measurement, the first UE 904 and the base station 902 may be configured to generate the SK based on a combination of different positioning measurements (e.g., based on RSTD vector, UE Rx-Tx time difference, and RSRP vector). As such, the chance of the second UE 906 obtaining the same measurement results as the first UE 604 for different types of positioning measurements (and thereby deriving the same SK) may become much smaller compared to the configuration where just one positioning measurement is used for deriving the SK. For example, while the second UE 906 may obtain similar RSTD measurement as the first UE 904 when the second UE 906 is in proximity to the first UE 904, the chance of the second UE 906 also obtaining the same measurements for the UE Rx-Tx time difference and/or the RSRP is greatly reduced. Thus, the second UE 906 is less likely to generate the same SK as the first UE 904 when a combination of positioning measurements are used for generating the SK.

In one example, the first UE 904 may be configured by a serving base station (e.g., the base station 902), a location server (e.g., an LMF), or an external application regarding, which positioning measurements (e.g., RSTD, UE Rx-Tx time difference, RSRP, etc.), which PRS resources, which TRPs, which PRS resource sets, which PFLs, and/or which bands, are going to be used by the UE 904 for deriving one or multiple SKs. In addition, there may be a configuration of a positioning frequency layer (PFL) that is just configured for the purpose of SK extraction. A PFL (which may also be referred to as a “frequency layer”) may refer to a collection of one or more PRS resource sets across one or more TRPs that have the same values for certain parameters.

In another example, the first UE 904 may report to a serving base station (e.g., the base station 902), a location server (e.g., an LMF), or an external application regarding, a quality metric of the positioning measurements (e.g., RSTD, RSRP, UE Rx-Tx time differences, etc.), which may be used (e.g., by the base station or location server) for determining how secure the derived/extracted SK is. For example, if the first UE 904 determines that the positioning measurements have an uncertainty of plus and minus (+/−) X meters, then the derived/extracted SK may be secure as long as the second UE 906 (e.g., an attacker) is not within plus and minus X meters to the first UE 904. Thus, the first UE 904 may transmit a quality metric to the base station 902 indicating the positioning measurement(s) used and the corresponding uncertainty. Based on the quality metric or how secure the derived/extracted SK is, the serving base station or the location server may determine whether additional positioning measurement(s) is to be included or excluded for deriving/extracting the SK. In some examples, the quality metric provided by a UE may also be used by the serving base station or the location server for modifying positioning measurements or uncertainties associated with the positioning measurements that are used for deriving the SK.

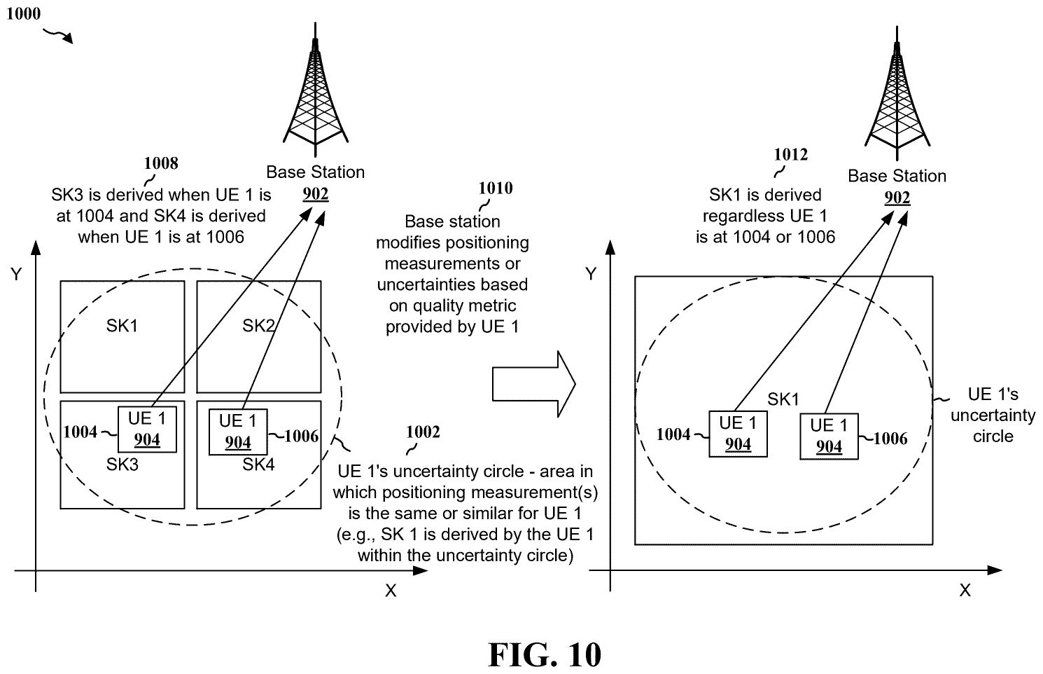

FIG. 10 is a diagram 1000 illustrating an example of a base station modifying positioning measurements or uncertainties associated with the positioning measurements based on the quality metric provided by a UE in accordance with various aspects of the present disclosure. The first UE 904 and the base station 902 may each be specified to derive the SK independently, such as described in connection with FIGS. 7 and 8. For example, the first UE 904 may derive the SK based on the AoA of the PRS received from the base station 902, and the base station 902 may also derive the SK based on the AoA of the SRS received from the first UE 904.

In some scenarios, if the positioning measurement(s) performed by the first UE 904 has an uncertainty exceeding a threshold (e.g., the uncertainty range is high such as X=+/−20 meters), different SKs may be derived at the first UE 904 and the base station 902. For example, as shown at 1002, the AoA measured by the first UE 904 may include an uncertainty circle (e.g., +/−20 meters within the first UE 904), such that the AoA measurements performed by the first UE 904 may be the same or similar within the uncertainty circle. For example, the AoA measured by the first UE 904 at 1004 and 1006 may be the same, such that the SK derived by the first UE 904 at 1004 and 1006 may also be the same (e.g., assuming it is a first SK (SK 1)). On the other hand, the positioning measurement(s) performed by the base station 902 may have a lower uncertainty compared to the positioning measurement(s) performed by the UE 904 as the base station 902 may be using hardware components that have higher accuracy and/or processing capability. Thus, the AoA measured by the base station 902 may be different when the first UE 904 is at 1004 or 1006, resulting in the base station 902 generating different SKs when the first UE 904 is at 1004 or 1006. For example, as shown at 1008, the base station 902 may generate a third SK (SK 3) when the first UE 904 is at 1004 and a fourth SK (SK 4) when the first UE 904 is at 1004, which may be different from the SK (e.g., SK 1) generated by the first UE 904.

As such, after the first UE 904 reports the quality metric associated with the positioning measurements (which may include the uncertainties associated with the positioning measurements), as shown at 1010, the base station 902 may adjust its positioning measurements and/or measurement parameters based on the quality metric provided by the first UE 904, such that the SK derived by the base station 902 may be the same regardless where the first UE 904 is within the uncertainty circle of the first UE 904. For example, as shown at 1012, the base station 902 may be configured to generate the first SK when the first UE 904 is within a certain region (e.g., +/−20 meters of the first UE 904's position) or when the measured AoA is within a certain range (e.g., 30 to 35 degrees).

In another aspect of the present disclosure, one or more base stations that are associated with a UE positioning session may select a set of positioning parameters for a UE positioning session (e.g., parameters for transmitting reference signals), where the set of positioning parameters may be used by the one or more base stations and also the UE participating in the UE positioning session for extracting an SK for communicating with each other. As such, the one or more base stations may skip performing the positioning measurement(s). For example, a collection of base stations may select a list/range of DL-AoDs for transmitting the PRSs (e.g., 30 degrees plus and minus 2 degrees) to a UE participating in a UE positioning session, where the list/range of DL-AoDs may be used by the one or more base stations for generating an SK. Then, the UE may measure the PRSs from the one or more base stations based on the list/range of DL-AoDs and use the measurements to extract the same SK at the UE side. In some examples, the UE may send a request to the network (e.g., the one or more base stations or a location server) that it specifies such a positioning measurement-based SK extraction. For example, an external client associated with the UE or the UE positioning session may send a request to an LMF that it specifies such a positioning measurement-based SK extraction. In response, the LMF may coordinate the transitions of the one or more base stations in order for them to transmit PRSs with the selected DL-AoDs.

Similar mechanism may also be applied at a UE participating in a UE positioning session. For example, a UE may select a list/range of UL-AoDs for transmitting SRSs towards one or more base stations, where the list/range of UL-AoDs may be used by the UE for generating an SK. Then, the one or more base stations may measure the SRSs from the UE based on the list/range of UL-AoDs and use the measurements to extract the same SK at the network/base station side. Similarly, an application client at the UE may send a request to an LMF for the LMF to configure the one or more base stations to measure and report the UL-AoD measurements so that an SK may be extracted at the network side.

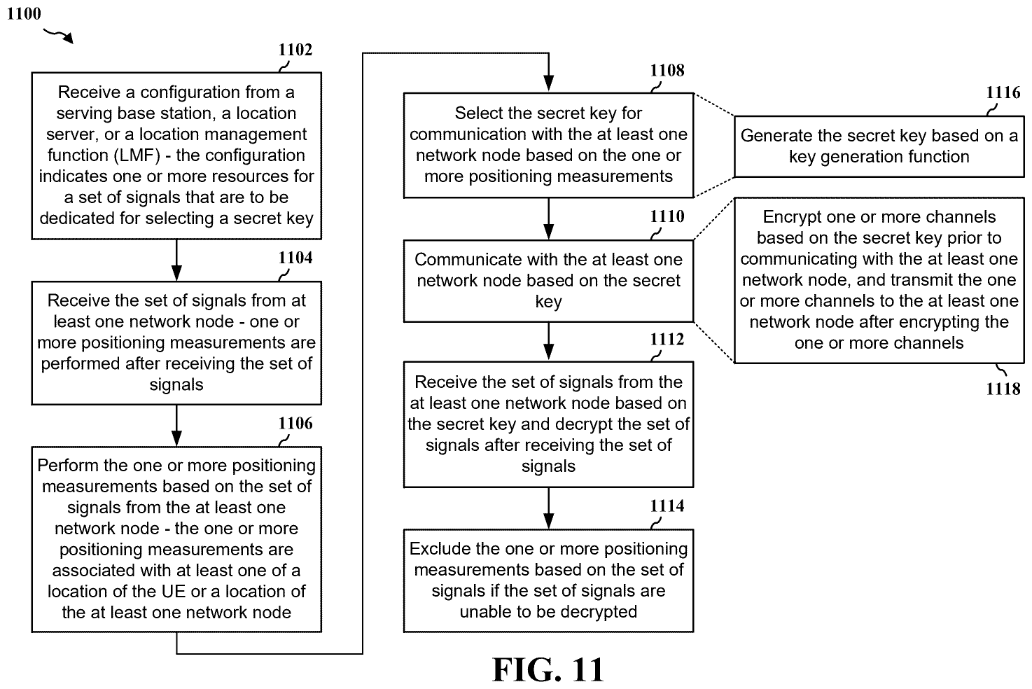

FIG. 11 is a flowchart 1100 of a method of wireless communication. The method may be performed by a UE (e.g., the UE 104, 404, 604, 802, 904; the apparatus 1304). The method may enable the UE to derive an SK based on positioning measurements, and use the SK for performing the UE positioning to enhance the security and integrity of the UE positioning.

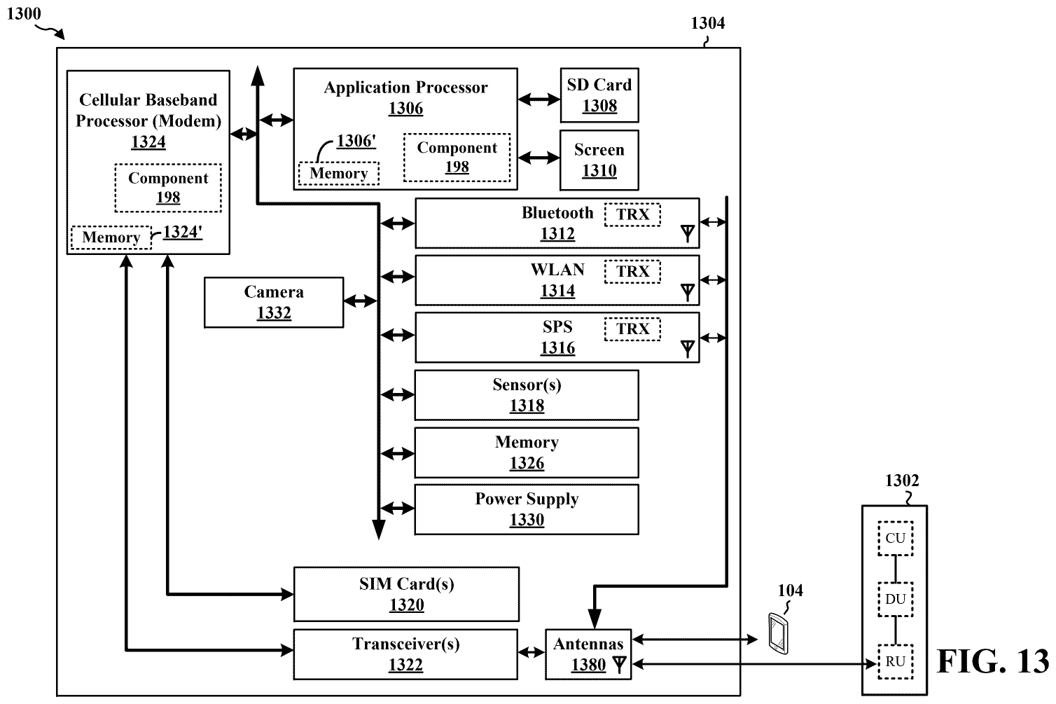

At 1102, the UE may receive a configuration from a serving base station, a location server, or an LMF, where the configuration may indicate one or more resources for a set of signals that are to be dedicated for selecting a secret key, such as described in connection with FIG. 8. For example, the UE 802 may receive a configuration from the base station 804, the server 820, or an LMF, that indicates resource(s) for a set of positioning reference signals that are to be dedicated for selecting a secret key. The reception of the configuration may be performed by, e.g., the SK generation and application component 198 and/or the transceiver(s) 1322 of the apparatus 1304 in FIG. 13.

At 1104, the UE may receive the set of signals from at least one network node, where one or more positioning measurements may be performed after receiving the set of signals, such as described in connection with FIG. 8. For example, at 806, the UE 802 may receive PRS from the base station 804, where one or more positioning measurements may be performed by the UE 802 after receiving the PRS. The reception of the set of signals from at least one network node may be performed by, e.g., the SK generation and application component 198 and/or the transceiver(s) 1322 of the apparatus 1304 in FIG. 13.

At 1106, the UE may perform the one or more positioning measurements based on the set of signals from the at least one network node, where the one or more positioning measurements may be associated with at least one of a location of the UE or a location of the at least one network node, such as described in connection with FIG. 8. For example, at 808, the UE 802 may measure parameter(s) associated with positioning based on positioning reference signal(s) received from the base station 804. The positioning measurements may be performed by, e.g., the SK generation and application component 198 of the apparatus 1304 in FIG. 13.

In one example, the at least one network node includes at least one TRP, a base station or a component of the base station, at least one sidelink device, at least one second UE, or a combination thereof.

In another example, the set of signals includes PRSs, SSBs, CSI-RSs, DMRSs, sidelink reference signals, or a combination thereof.

In another example, the one or more positioning measurements includes: RSRP, path RSRP, RSTD, phase path measurements, RTOA, AoA, ZoA, SINR, one or more quality metrics, Doppler shift, Rx-Tx time difference, or a combination thereof.

In another example, the one or more positioning measurements are further associated with an uncertainty margin, such that any secret keys selected within the uncertainty margin are a same secret key.

At 1108, the UE may select the secret key for communication with the at least one network node based on the one or more positioning measurements, such as described in connection with FIG. 8. For example, at 810, 812, and 814, the UE 802 may select a secret key for communication with the base station 804 based on the positioning measurements. The selection of the secret key may be performed by, e.g., the SK generation and application component 198 of the apparatus 1304 in FIG. 13.

In one example, as shown at 1116, in selecting the secret key for communication with the at least one network node based on the one or more positioning measurements, the UE may generate the secret key based on a key generation function.

In another example, the selection of the secret key is independent of the at least one network node.

At 1110, the UE may communicate with the at least one network node based on the secret key, such as described in connection with FIG. 8. For example, at 816, the UE 802 may communicate with the base station 804 based on the secret key. The communication with the at least one network node based on the secret key may be performed by, e.g., the SK generation and application component 198 and/or the transceiver(s) 1322 of the apparatus 1304 in FIG. 13.

In one example, as shown at 1118, in communicating with the at least one network node based on the secret key, the UE may encrypt one or more channels based on the secret key prior to communicating with the at least one network node, and transmit the one or more channels to the at least one network node after encrypting the one or more channels. In such an example, the one or more channels may be used for extracting the secret key.

At 1112, the UE may receive the set of signals from the at least one network node based on the secret key and decrypt the set of signals after receiving the set of signals, such as described in connection with FIG. 8. The reception of the set of signals from the at least one network node based on the secret key may be performed by, e.g., the SK generation and application component 198 and/or the transceiver(s) 1322 of the apparatus 1304 in FIG. 13.

At 1114, the UE may exclude the one or more positioning measurements based on the set of signals if the set of signals are unable to be decrypted, such as described in connection with FIG. 8. The exclusion of the one or more positioning measurements may be performed by, e.g., the SK generation and application component 198 and/or the transceiver(s) 1322 of the apparatus 1304 in FIG. 13.

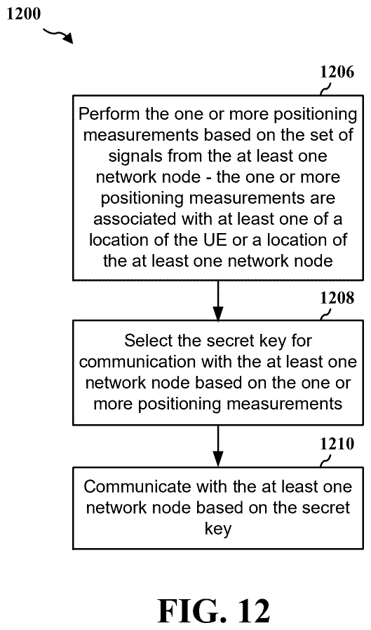

FIG. 12 is a flowchart 1200 of a method of wireless communication. The method may be performed by a UE (e.g., the UE 104, 404, 604, 802, 904; the apparatus 1304). The method may enable the UE to derive an SK based on positioning measurements, and use the SK for performing the UE positioning to enhance the security and integrity of the UE positioning.

At 1206, the UE may perform the one or more positioning measurements based on the set of signals from the at least one network node, where the one or more positioning measurements may be associated with at least one of a location of the UE or a location of the at least one network node, such as described in connection with FIG. 8. For example, at 808, the UE 802 may measure parameter(s) associated with positioning based on positioning reference signal(s) received from the base station 804. The positioning measurements may be performed by, e.g., the SK generation and application component 198 of the apparatus 1304 in FIG. 13.

In one example, the at least one network node includes at least one TRP, a base station or a component of the base station, at least one sidelink device, at least one second UE, or a combination thereof.

In another example, the set of signals includes PRSs, SSBs, CSI-RSs, DMRSs, sidelink reference signals, or a combination thereof.

In another example, the one or more positioning measurements includes: RSRP, path RSRP, RSTD, phase path measurements, RTOA, AoA, ZoA, SINR, one or more quality metrics, Doppler shift, Rx-Tx time difference, or a combination thereof.

In another example, the one or more positioning measurements are further associated with an uncertainty margin, such that any secret keys selected within the uncertainty margin are a same secret key.

At 1208, the UE may select the secret key for communication with the at least one network node based on the one or more positioning measurements, such as described in connection with FIG. 8. For example, at 810, 812, and 814, the UE 802 may select a secret key for communication with the base station 804 based on the positioning measurements. The selection of the secret key may be performed by, e.g., the SK generation and application component 198 of the apparatus 1304 in FIG. 13.

In one example, in selecting the secret key for communication with the at least one network node based on the one or more positioning measurements, the UE may generate the secret key based on a key generation function.

In another example, the selection of the secret key is independent of the at least one network node.

At 1210, the UE may communicate with the at least one network node based on the secret key, such as described in connection with FIG. 8. For example, at 816, the UE 802 may communicate with the base station 804 based on the secret key. The communication with the at least one network node based on the secret key may be performed by, e.g., the SK generation and application component 198 and/or the transceiver(s) 1322 of the apparatus 1304 in FIG. 13.

In one example, in communicating with the at least one network node based on the secret key, the UE may encrypt one or more channels based on the secret key prior to communicating with the at least one network node, and transmit the one or more channels to the at least one network node after encrypting the one or more channels. In such an example, the one or more channels may be used for extracting the secret key.

In another example, the UE may receive a configuration from a serving base station, a location server, or an LMF, where the configuration may indicate one or more resources for a set of signals that are to be dedicated for selecting a secret key, such as described in connection with FIG. 8. For example, the UE 802 may receive a configuration from the base station 804, the server 820, or an LMF, that indicates resource(s) for a set of positioning reference signals that are to be dedicated for selecting a secret key. The reception of the configuration may be performed by, e.g., the SK generation and application component 198 and/or the transceiver(s) 1322 of the apparatus 1304 in FIG. 13.

In another example, the UE may receive the set of signals from at least one network node, where one or more positioning measurements may be performed after receiving the set of signals, such as described in connection with FIG. 8. For example, at 806, the UE 802 may receive PRS from the base station 804, where one or more positioning measurements may be performed by the UE 802 after receiving the PRS. The reception of the set of signals from at least one network node may be performed by, e.g., the SK generation and application component 198 and/or the transceiver(s) 1322 of the apparatus 1304 in FIG. 13.

In another example, the UE may receive the set of signals from the at least one network node based on the secret key and decrypt the set of signals after receiving the set of signals, such as described in connection with FIG. 8. The reception of the set of signals from the at least one network node based on the secret key may be performed by, e.g., the SK generation and application component 198 and/or the transceiver(s) 1322 of the apparatus 1304 in FIG. 13.

In another example, the UE may exclude the one or more positioning measurements based on the set of signals if the set of signals are unable to be decrypted, such as described in connection with FIG. 8. The exclusion of the one or more positioning measurements may be performed by, e.g., the SK generation and application component 198 and/or the transceiver(s) 1322 of the apparatus 1304 in FIG. 13.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see 350 of FIG. 3) and include the additional modules of the apparatus 1304.

As discussed supra, the component 198 is configured to perform one or more positioning measurements based on a set of signals from at least one network node, where the one or more positioning measurements are associated with at least one of a location of the UE or a location of the at least one network node; select a secret key for communication with the at least one network node based on the one or more positioning measurements; and communicate with the at least one network node based on the secret key. The component 198 may be within the cellular baseband processor 1324, the application processor 1306, or both the cellular baseband processor 1324 and the application processor 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, includes means for performing one or more positioning measurements based on a set of signals from at least one network node, where the one or more positioning measurements are associated with at least one of a location of the UE or a location of the at least one network node. The apparatus 1304 may also include means for selecting a secret key for communication with the at least one network node based on the one or more positioning measurements. The apparatus 1304 may also include means for communicating with the at least one network node based on the secret key.

In one configuration, the at least one network node includes at least one TRP, a base station or a component of the base station, at least one sidelink device, at least one second UE, or a combination thereof.

In another configuration, the set of signals includes PRSs, SSBs, CSI-RSs, DMRSs, sidelink reference signals, or a combination thereof.

In another configuration, the one or more positioning measurements includes: RSRP, path RSRP, RSTD, phase path measurements, RTOA, AoA, ZoA, SINR, one or more quality metrics, Doppler shift, Rx-Tx time difference, or a combination thereof.

In another configuration, the one or more positioning measurements are further associated with an uncertainty margin, such that any secret keys selected within the uncertainty margin are a same secret key.

In another configuration, the apparatus 1304 includes means for selecting the secret key for communication with the at least one network node based on the one or more positioning measurements. In such a configuration, the means for selecting the secret key for communication with the at least one network node based on the one or more positioning measurements may include configuring the apparatus 1304 to generate the secret key based on a key generation function.

In another configuration, the selection of the secret key is independent of the at least one network node.

In another configuration, the apparatus 1304 includes means for communicating with the at least one network node based on the secret key. In such a configuration, the means for communicating with the at least one network node based on the secret key may include configuring the apparatus 1304 to encrypt one or more channels based on the secret key prior to communicating with the at least one network node, and transmit the one or more channels to the at least one network node after encrypting the one or more channels. In such a configuration, the one or more channels may be used for extracting the secret key.

In another configuration, the apparatus 1304 includes means for receiving a configuration from a serving base station, a location server, or an LMF, where the configuration may indicate one or more resources for a set of signals that are to be dedicated for selecting a secret key.

In another configuration, the apparatus 1304 includes means for receiving the set of signals from at least one network node.

In another configuration, the apparatus 1304 includes means for receiving the set of signals from the at least one network node based on the secret key and means for decrypting the set of signals after receiving the set of signals.

In another configuration, the apparatus 1304 includes means for excluding the one or more positioning measurements based on the set of signals if the set of signals are unable to be decrypted.

The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

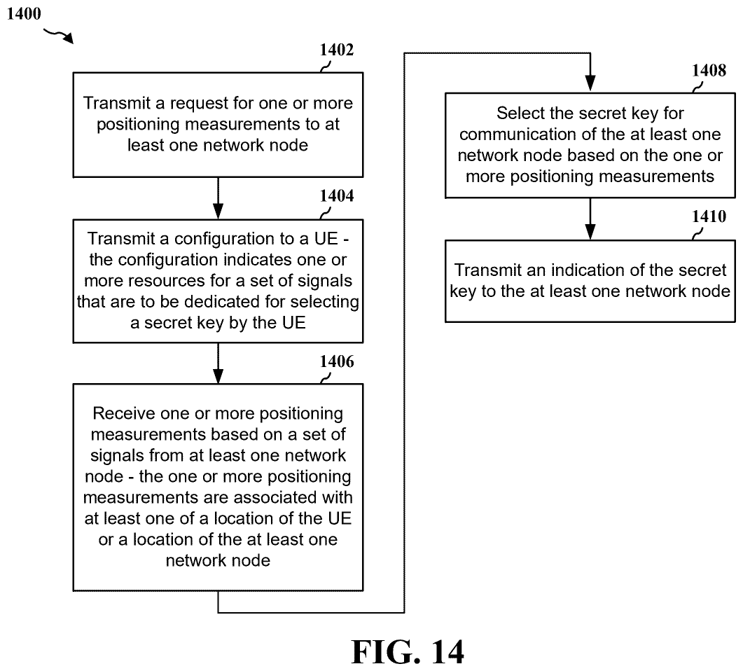

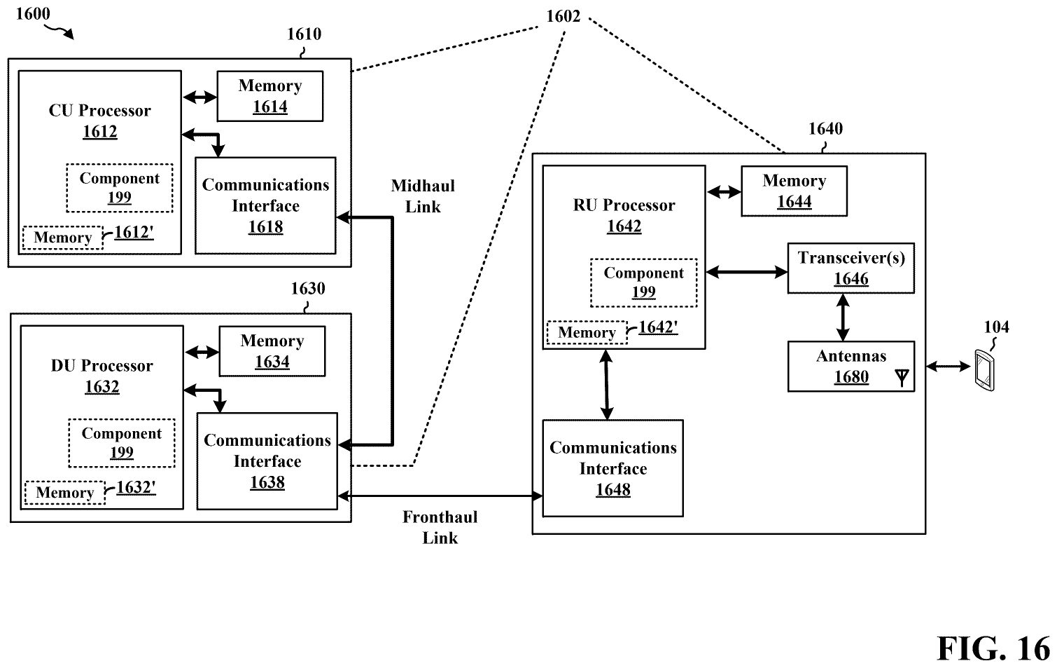

FIG. 14 is a flowchart 1400 of a method of wireless communication. The method may be performed by a location server (e.g., the server 820; the network entity 1602). At 1402, the location server may transmit a request for the one or more positioning measurements to the at least one network node, such as described in connection with FIG. 8. For example, at 822, the server 820 may request the base station 804 to perform positioning measurements. The transmission of the request may be performed by, e.g., the SK generation and application component 199 and/or the transceiver(s) 1646 of the network entity 1602 in FIG. 16.

At 1404, the location server may transmit a configuration to the UE, where the configuration may indicate one or more resources for the set of signals that are to be dedicated for selecting the secret key by the UE, such as described in connection with FIG. 8. For example, the server 820 may transmit a configuration to the UE 802 that indicates one or more resources for the set of signals that are to be dedicated for selecting the secret key by the UE 802. The transmission of the configuration may be performed by, e.g., the SK generation and application component 199 and/or the transceiver(s) 1646 of the network entity 1602 in FIG. 16.

At 1406, the location server may receive one or more positioning measurements based on a set of signals from at least one network node, where the one or more positioning measurements are associated with at least one of a location of a UE or a location of the at least one network node, such as described in connection with FIG. 8. For example, at 824, the server 820 may receive positioning measurements based on positioning reference signals from the base station 804, where the positioning measurements may be associated with the location of the UE 802 or the location of the base station 804. The reception of the one or more positioning measurements may be performed by, e.g., the SK generation and application component 199 and/or the transceiver(s) 1646 of the network entity 1602 in FIG. 16.

In one example, the location server corresponds to an LMF, and the at least one network node includes at least one TRP, a base station or a component of the base station, at least one sidelink device, at least one second UE, or a combination thereof.

In another example, the set of signals are SRSs.

In another example, the one or more positioning measurements includes: RSRP, path RSRP, RSTD, phase path measurements, RTOA, AoA, ZoA, SINR, one or more quality metrics, Doppler shift, Rx-Tx time difference, or a combination thereof.

In another example, the one or more positioning measurements are further associated with an uncertainty margin, such that any secret keys selected within the uncertainty margin are a same secret key.

At 1408, the location server may select a secret key for communication of the at least one network node based on the one or more positioning measurements, such as described in connection with FIG. 8. For example, at 826, the server 820 may select a secret key for communication of the base station 804 based on the positioning measurements. The selection of the secret key may be performed by, e.g., the SK generation and application component 199 of the network entity 1602 in FIG. 16. In such an example, the location server may generate the secret key based on a key generation function.

In one example, the selection of the secret key is independent of the UE.

At 1410, the location server may transmit an indication of the secret key to the at least one network node, such as described in connection with FIG. 8. For example, at 828, the server 820 may transmit the generated secret key to the base station 804. The transmission of the indication of the secret key may be performed by, e.g., the SK generation and application component 199 and/or the transceiver(s) 1646 of the network entity 1602 in FIG. 16.

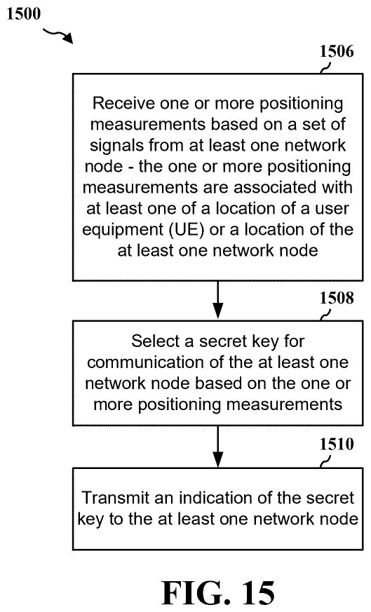

FIG. 15 is a flowchart 1500 of a method of wireless communication. The method may be performed by a location server (e.g., the server 820; the network entity 1602).

At 1506, the location server may receive one or more positioning measurements based on a set of signals from at least one network node, where the one or more positioning measurements are associated with at least one of a location of a UE or a location of the at least one network node, such as described in connection with FIG. 8. For example, at 824, the server 820 may receive positioning measurements based on positioning reference signals from the base station 804, where the positioning measurements may be associated with the location of the UE 802 or the location of the base station 804. The reception of the one or more positioning measurements may be performed by, e.g., the SK generation and application component 199 and/or the transceiver(s) 1646 of the network entity 1602 in FIG. 16.

In one example, the location server corresponds to an LMF, and the at least one network node includes at least one TRP, a base station or a component of the base station, at least one sidelink device, at least one second UE, or a combination thereof.

In another example, the set of signals are SRSs.

In another example, the one or more positioning measurements includes: RSRP, path RSRP, RSTD, phase path measurements, RTOA, AoA, ZoA, SINR, one or more quality metrics, Doppler shift, Rx-Tx time difference, or a combination thereof.

In another example, the one or more positioning measurements are further associated with an uncertainty margin, such that any secret keys selected within the uncertainty margin are a same secret key.

In another example, the location server may transmit a request for the one or more positioning measurements to the at least one network node, such as described in connection with FIG. 8. For example, at 822, the server 820 may request the base station 804 to perform positioning measurements. The transmission of the request may be performed by, e.g., the SK generation and application component 199 and/or the transceiver(s) 1646 of the network entity 1602 in FIG. 16.

In another example, the location server may transmit a configuration to the UE, where the configuration may indicate one or more resources for the set of signals that are to be dedicated for selecting the secret key by the UE, such as described in connection with FIG. 8. For example, the server 820 may transmit a configuration to the UE 802 that indicates one or more resources for the set of signals that are to be dedicated for selecting the secret key by the UE 802. The transmission of the configuration may be performed by, e.g., the SK generation and application component 199 and/or the transceiver(s) 1646 of the network entity 1602 in FIG. 16.

At 1508, the location server may select a secret key for communication of the at least one network node based on the one or more positioning measurements, such as described in connection with FIG. 8. For example, at 826, the server 820 may select a secret key for communication of the base station 804 based on the positioning measurements. The selection of the secret key may be performed by, e.g., the SK generation and application component 199 of the network entity 1602 in FIG. 16. In such an example, the location server may generate the secret key based on a key generation function.

In one example, the selection of the secret key is independent of the UE.

At 1510, the location server may transmit an indication of the secret key to the at least one network node, such as described in connection with FIG. 8. For example, at 828, the server 820 may transmit the generated secret key to the base station 804. The transmission of the indication of the secret key may be performed by, e.g., the SK generation and application component 199 and/or the transceiver(s) 1646 of the network entity 1602 in FIG. 16.

FIG. 16 is a diagram 1600 illustrating an example of a hardware implementation for a network entity 1602. The network entity 1602 may be a location server, a component of a location server, or may implement location server functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include a CU processor 1612. The CU processor 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include a DU processor 1632. The DU processor 1632 may include on-chip memory 1632′. In some aspects, the DU 1630 may further include additional memory modules 1634 and a communications interface 1638. The DU 1630 communicates with the RU 1640 through a fronthaul link. The RU 1640 may include an RU processor 1642. The RU processor 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to receive one or more positioning measurements based on a set of signals from at least one network node, where the one or more positioning measurements are associated with at least one of a location of a UE or a location of the at least one network node; select a secret key for communication of the at least one network node based on the one or more positioning measurements; and transmit an indication of the secret key to the at least one network node. The component 199 may be within one or more processors of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1602 may include a variety of components configured for various functions. In one configuration, the network entity 1602 includes means for receiving one or more positioning measurements based on a set of signals from at least one network node, where the one or more positioning measurements are associated with at least one of a location of a UE or a location of the at least one network node. The network entity 1602 may also include means for select a secreting key for communication of the at least one network node based on the one or more positioning measurements. The network entity 1602 may also include means for transmitting an indication of the secret key to the at least one network node.

In one configuration, the network entity 1602 corresponds to a location server or an LMF, and the at least one network node includes at least one TRP, a base station or a component of the base station, at least one sidelink device, at least one second UE, or a combination thereof.

In another configuration, the set of signals are SRSs.

In another configuration, the one or more positioning measurements includes: RSRP, path RSRP, RSTD, phase path measurements, RTOA, AoA, ZoA, SINR, one or more quality metrics, Doppler shift, Rx-Tx time difference, or a combination thereof.

In another configuration, the one or more positioning measurements are further associated with an uncertainty margin, such that any secret keys selected within the uncertainty margin are a same secret key.

In another configuration, the network entity 1602 includes means for transmitting a request for the one or more positioning measurements to the at least one network node.

In another configuration, the network entity 1602 includes means for transmitting a configuration to the UE, where the configuration may indicate one or more resources for the set of signals that are to be dedicated for selecting the secret key by the UE.

In another configuration, the means for selecting a secret key for communication of the at least one network node based on the one or more positioning measurements includes configuring the network entity 1602 to generate the secret key based on a key generation function.

In another configuration, the selection of the secret key is independent of the UE.

The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

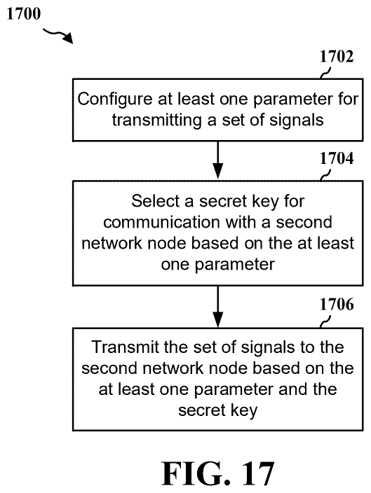

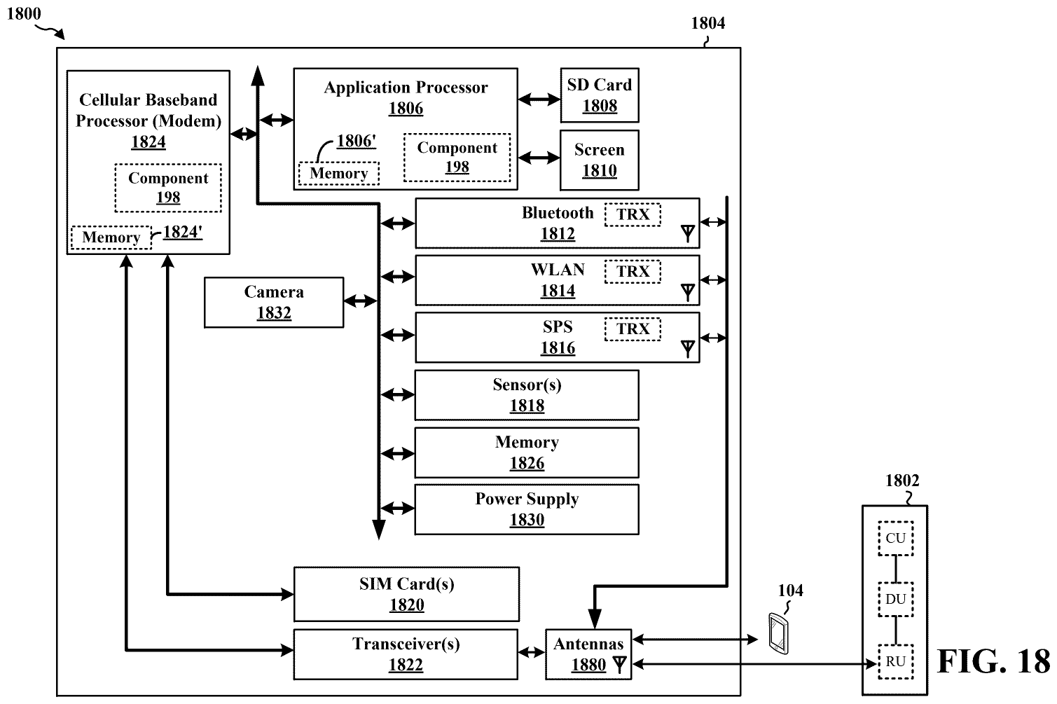

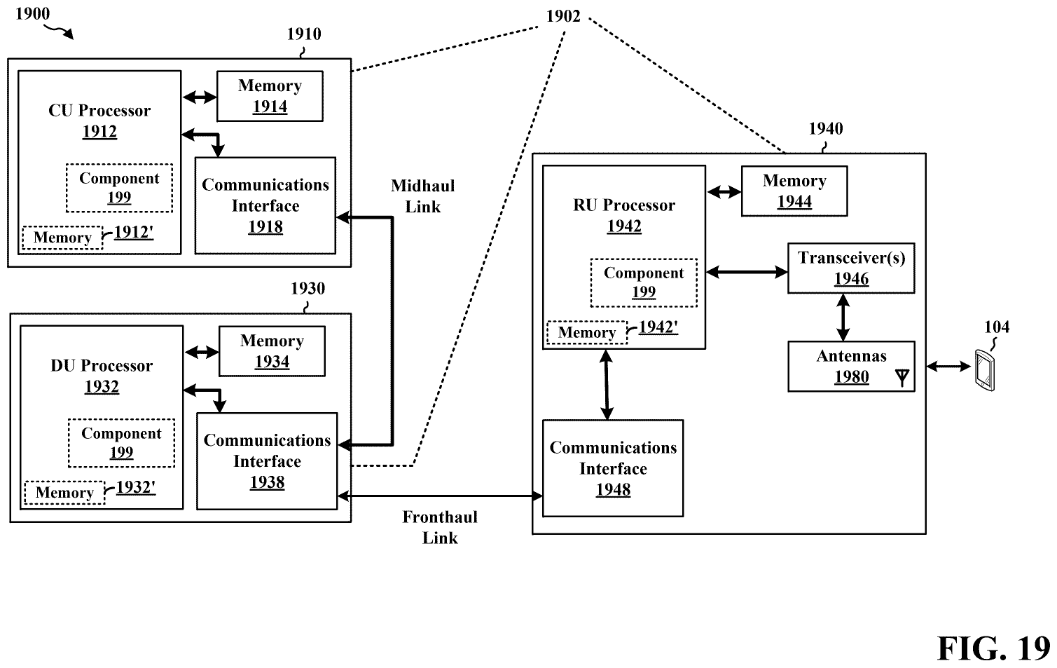

FIG. 17 is a flowchart 1700 of a method of wireless communication. The method may be performed by a first network node (e.g., the UE 104, 802, 904; the base station 102, 804, 902; the apparatus 1804; the network entity 1902). At 1702, the first network node may configure at least one parameter for transmitting a set of signals, such as described in connection with FIG. 8. The configuration of the at least one parameter for transmitting a set of signals may be performed by, e.g., the SK generation and application component 198 of the apparatus 1804 in FIG. 18 and/or the SK generation and application component 199 of the network entity 1902 in FIG. 19.

In one example, the set of signals include PRSs, SSBs, CSI-RSs, DMRSs, sidelink reference signals, or a combination thereof.

In another example, the at least one parameter includes an AoD for each of the set of signals.

At 1704, the first network node may select a secret key for communication with a second network node based on the at least one parameter, such as described in connection with FIG. 8. The selection of the secret key may be performed by, e.g., the SK generation and application component 198 of the apparatus 1804 in FIG. 18 and/or the SK generation and application component 199 of the network entity 1902 in FIG. 19.

In one example, the first network node corresponds to a UE and the second network node corresponds to at least one base station. In such an example, the first network node may transmit a request to a location server or an LMF, where the request specifies a positioning measurement-based secret key extraction.

In another example, the first network node corresponds to at least one base station and the second network node corresponds to a UE. In such an example, the first network node may receive the at least one parameter from a location server or an LMF. In another example, the first network node may perform one or more positioning measurements for a second set of signals from the second network node, report the one or more positioning measurements to a location server or an LMF, and receive an indication of the secret key from the location server or the LMF.

At 1706, the first network node may transmit the set of signals to the second network node based on the at least one parameter and the secret key, such as described in connection with FIG. 8. The transmission of the set of signals based on the at least one parameter and the secret key may be performed by, e.g., the SK generation and application component 198 of the apparatus 1804 in FIG. 18 and/or the SK generation and application component 199 of the network entity 1902 in FIG. 19.

FIG. 18 is a diagram 1800 illustrating an example of a hardware implementation for an apparatus 1804. The apparatus 1804 may be a UE, a component of a UE, or may implement UE functionality. In some aspects, the apparatus 1804 may include a cellular baseband processor 1824 (also referred to as a modem) coupled to one or more transceivers 1822 (e.g., cellular RF transceiver). The cellular baseband processor 1824 may include on-chip memory 1824′. In some aspects, the apparatus 1804 may further include one or more subscriber identity modules (SIM) cards 1820 and an application processor 1806 coupled to a secure digital (SD) card 1808 and a screen 1810. The application processor 1806 may include on-chip memory 1806′. In some aspects, the apparatus 1804 may further include a Bluetooth module 1812, a WLAN module 1814, an SPS module 1816 (e.g., GNSS module), one or more sensor modules 1818 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1826, a power supply 1830, and/or a camera 1832. The Bluetooth module 1812, the WLAN module 1814, and the SPS module 1816 may include an on-chip transceiver (TRX) (or in some cases, just a receiver (RX)). The Bluetooth module 1812, the WLAN module 1814, and the SPS module 1816 may include their own dedicated antennas and/or utilize the antennas 1880 for communication. The cellular baseband processor 1824 communicates through the transceiver(s) 1822 via one or more antennas 1880 with the UE 104 and/or with an RU associated with a network entity 1802. The cellular baseband processor 1824 and the application processor 1806 may each include a computer-readable medium/memory 1824′, 1806′, respectively. The additional memory modules 1826 may also be considered a computer-readable medium/memory. Each computer-readable medium/memory 1824′, 1806′, 1826 may be non-transitory. The cellular baseband processor 1824 and the application processor 1806 are each responsible for general processing, including the execution of software stored on the computer-readable medium/memory. The software, when executed by the cellular baseband processor 1824/application processor 1806, causes the cellular baseband processor 1824/application processor 1806 to perform the various functions described supra. The computer-readable medium/memory may also be used for storing data that is manipulated by the cellular baseband processor 1824/application processor 1806 when executing software. The cellular baseband processor 1824/application processor 1806 may be a component of the UE 350 and may include the memory 360 and/or at least one of the TX processor 368, the RX processor 356, and the controller/processor 359. In one configuration, the apparatus 1804 may be a processor chip (modem and/or application) and include just the cellular baseband processor 1824 and/or the application processor 1806, and in another configuration, the apparatus 1804 may be the entire UE (e.g., see 350 of FIG. 3) and include the additional modules of the apparatus 1804.

As discussed supra, the component 198 is configured to configure at least one parameter for transmitting a set of signals; select a secret key for communication with a second network node based on the at least one parameter; and transmit the set of signals to the second network node based on the at least one parameter and the secret key. The component 198 may be within the cellular baseband processor 1824, the application processor 1806, or both the cellular baseband processor 1824 and the application processor 1806. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1804 may include a variety of components configured for various functions. In one configuration, the apparatus 1804, and in particular the cellular baseband processor 1824 and/or the application processor 1806, includes means for configuring at least one parameter for transmitting a set of signals. The apparatus 1804 may also include means for selecting a secret key for communication with a second network node based on the at least one parameter. The apparatus 1804 may also include means for transmitting the set of signals to the second network node based on the at least one parameter and the secret key.

In one configuration, the set of signals include PRSs, SSBs, CSI-RSs, DMRSs, sidelink reference signals, or a combination thereof.

In another configuration, the at least one parameter includes an AoD for each of the set of signals.

In another configuration, the first network node corresponds to a UE and the second network node corresponds to at least one base station. In such a configuration, the apparatus 1804 includes means for transmitting a request to a location server or an LMF, where the request specifies a positioning measurement-based secret key extraction.

In another configuration, the first network node corresponds to at least one base station and the second network node corresponds to a UE. In such a configuration, the apparatus 1804 includes means for receiving the at least one parameter from a location server or an LMF. In another configuration, the apparatus 1804 includes means for performing one or more positioning measurements for a second set of signals from the second network node, means for reporting the one or more positioning measurements to a location server or an LMF, and means for receiving an indication of the secret key from the location server or the LMF.

The means may be the component 198 of the apparatus 1804 configured to perform the functions recited by the means. As described supra, the apparatus 1804 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 19 is a diagram 1900 illustrating an example of a hardware implementation for a network entity 1902. The network entity 1902 may be a BS, a component of a BS, or may implement BS functionality. The network entity 1902 may include at least one of a CU 1910, a DU 1930, or an RU 1940. For example, depending on the layer functionality handled by the component 199, the network entity 1902 may include the CU 1910; both the CU 1910 and the DU 1930; each of the CU 1910, the DU 1930, and the RU 1940; the DU 1930; both the DU 1930 and the RU 1940; or the RU 1940. The CU 1910 may include a CU processor 1912. The CU processor 1912 may include on-chip memory 1912′. In some aspects, the CU 1910 may further include additional memory modules 1914 and a communications interface 1918. The CU 1910 communicates with the DU 1930 through a midhaul link, such as an F1 interface. The DU 1930 may include a DU processor 1932. The DU processor 1932 may include on-chip memory 1932′. In some aspects, the DU 1930 may further include additional memory modules 1934 and a communications interface 1938. The DU 1930 communicates with the RU 1940 through a fronthaul link. The RU 1940 may include an RU processor 1942. The RU processor 1942 may include on-chip memory 1942′. In some aspects, the RU 1940 may further include additional memory modules 1944, one or more transceivers 1946, antennas 1980, and a communications interface 1948. The RU 1940 communicates with the UE 104. The on-chip memory 1912′, 1932′, 1942′ and the additional memory modules 1914, 1934, 1944 may each be considered a computer-readable medium/memory. Each computer-readable medium/memory may be non-transitory. Each of the processors 1912, 1932, 1942 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to configure at least one parameter for transmitting a set of signals; select a secret key for communication with a second network node based on the at least one parameter; and transmit the set of signals to the second network node based on the at least one parameter and the secret key. The component 199 may be within one or more processors of one or more of the CU 1910, DU 1930, and the RU 1940. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1902 may include a variety of components configured for various functions. In one configuration, the network entity 1902 includes means for configuring at least one parameter for transmitting a set of signals. The network entity 1902 may also include means for selecting a secret key for communication with a second network node based on the at least one parameter. The network entity 1902 may also include means for transmitting the set of signals to the second network node based on the at least one parameter and the secret key.

In one configuration, the set of signals include PRSs, SSBs, CSI-RSs, DMRSs, sidelink reference signals, or a combination thereof.

In another configuration, the at least one parameter includes an AoD for each of the set of signals.

In another configuration, the first network node corresponds to a UE and the second network node corresponds to at least one base station. In such a configuration, the apparatus 1804 includes means for transmitting a request to a location server or an LMF, where the request specifies a positioning measurement-based secret key extraction.

In another configuration, the first network node corresponds to at least one base station and the second network node corresponds to a UE. In such a configuration, the apparatus 1804 includes means for receiving the at least one parameter from a location server or an LMF. In another configuration, the apparatus 1804 includes means for performing one or more positioning measurements for a second set of signals from the second network node, means for reporting the one or more positioning measurements to a location server or an LMF, and means for receiving an indication of the secret key from the location server or the LMF.

The means may be the component 199 of the network entity 1902 configured to perform the functions recited by the means. As described supra, the network entity 1902 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented. The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: performing one or more positioning measurements based on a set of signals from at least one network node, where the one or more positioning measurements are associated with at least one of a location of the UE or a location of the at least one network node; selecting a secret key for communication with the at least one network node based on the one or more positioning measurements; and communicating with the at least one network node based on the secret key.

Aspect 2 is the method of aspect 1, where the at least one network node includes at least one TRP, a base station or a component of the base station, at least one sidelink device, at least one second UE, or a combination thereof.

Aspect 3 is the method of aspect 2, where the set of signals includes PRSs, SSBs, CSI-RSs, DMRSs, sidelink reference signals, or a combination thereof.

Aspect 4 is the method of any of aspects 1 to 3, further including receiving the set of signals from the at least one network node, where the one or more positioning measurements are performed after receiving the set of signals.

Aspect 5 is the method of any of aspects 1 to 4, further including receiving a configuration from a serving base station, a location server, or an LMF, where the configuration indicates one or more resources for the set of signals that are to be dedicated for selecting the secret key.

Aspect 6 is the method of any of aspects 1 to 5, where the one or more positioning measurements includes: RSRP, path RSRP, RSTD, phase path measurements, RTOA, AoA, ZoA, SINR, one or more quality metrics, Doppler shift, Rx-Tx time difference, or a combination thereof.

Aspect 7 is the method of any of aspects 1 to 6, where selecting the secret key for the communication with the at least one network node includes generating the secret key based on a key generation function.

Aspect 8 is the method of any of aspects 1 to 7, where communicating with the at least one network node based on the secret key includes encrypting one or more channels based on the secret key prior to communicating with the at least one network node; and transmitting the one or more channels to the at least one network node after encrypting the one or more channels.

Aspect 9 is the method of aspect 8, where the one or more channels are used for extracting the secret key.

Aspect 10 is the method of any of aspects 1 to 9, where communicating with the at least one network node based on the secret key includes receiving the set of signals from the at least one network node based on the secret key; and decrypting the set of signals after receiving the set of signals.

Aspect 11 is the method of any of aspects 1 to 10, where the one or more positioning measurements are further associated with an uncertainty margin, such that any secret keys selected within the uncertainty margin are a same secret key.

Aspect 12 is the method of any of aspects 1 to 11, further including excluding the one or more positioning measurements based on the set of signals if the set of signals are unable to be decrypted.

Aspect 13 is the method of any of aspects 1 to 12, where the selection of the secret key is independent of the at least one network node.

Aspect 14 is an apparatus for wireless communication for implementing any of aspects 1 to 13.

Aspect 15 is an apparatus for wireless communication including means for implementing any of aspects 1 to 13.

Aspect 16 is a computer-readable medium storing computer executable code, where the code when executed by a processor causes the processor to implement any of aspects 1 to 13.

Aspect 17 is a method of wireless communication at a network entity, including: receiving one or more positioning measurements based on a set of signals from at least one network node, where the one or more positioning measurements are associated with at least one of a location of a UE or a location of the at least one network node; selecting a secret key for communication of the at least one network node based on the one or more positioning measurements; and transmitting an indication of the secret key to the at least one network node.

Aspect 18 is the method of aspect 17, where the network entity corresponds to a location server or an LMF, and the at least one network node includes at least one TRP, a base station or a component of the base station, at least one sidelink device, at least one second UE, or a combination thereof.

Aspect 19 is the method of any of aspect 17 or 18, where the set of signals are SRSs.

Aspect 20 is the method of any of aspects 17 to 19, further including transmitting a request for the one or more positioning measurements to the at least one network node.

Aspect 21 is the method of any of aspects 17 to 20, further including transmitting a configuration to the UE, where the configuration indicates one or more resources for the set of signals that are to be dedicated for selecting the secret key by the UE.

Aspect 22 is the method of any of aspects 17 to 21, where the one or more positioning measurements includes: RSRP, path RSRP, RSTD, phase path measurements, RTOA, AoA, ZoA, SINR, one or more quality metrics, Doppler shift, Rx-Tx time difference, or a combination thereof.

Aspect 23 is the method of any of aspects 17 to 22, where selecting the secret key for the communication of the at least one network node includes generating the secret key based on a key generation function.

Aspect 24 is the method of any of aspects 17 to 23, where the one or more positioning measurements are further associated with an uncertainty margin, such that any secret keys selected within the uncertainty margin are a same secret key.

Aspect 25 is the method of any of aspects 17 to 24, where the selection of the secret key is independent of the UE.

Aspect 26 is an apparatus for wireless communication for implementing any of aspects 17 to 25.

Aspect 27 is an apparatus for wireless communication including means for implementing any of aspects 17 to 25.

Aspect 28 is a computer-readable medium storing computer executable code, where the code when executed by a processor causes the processor to implement any of aspects 17 to 25.

Aspect 29 is a method of wireless communication at a first network node, including: configuring at least one parameter for transmitting a set of signals; selecting a secret key for communication with a second network node based on the at least one parameter; and transmitting the set of signals to the second network node based on the at least one parameter and the secret key.

Aspect 30 is the method of aspect 29, where the first network node corresponds to a UE and the second network node corresponds to at least one base station.

Aspect 31 is the method of aspect 30, further including transmitting a request to a location server or an LMF, where the request specifies a positioning measurement-based secret key extraction.

Aspect 32 is the method of any of aspects 29 to 31, where the first network node corresponds to at least one base station and the second network node corresponds to a UE.

Aspect 33 is the method of aspect 32, further including receiving the at least one parameter from a location server or a LMF.

Aspect 34 is the method of aspect 32, further including performing one or more positioning measurements for a second set of signals from the second network node; reporting the one or more positioning measurements to a location server or a LMF; and receiving an indication of the secret key from the location server or the LMF.

Aspect 35 is the method of any of aspects 29 to 34, where the set of signals include PRSs, SSBs, CSI-RSs, DMRSs, sidelink reference signals, or a combination thereof.

Aspect 36 is the method of any of aspects 29 to 35, where the at least one parameter includes an AoD for each of the set of signals.

Aspect 37 is an apparatus for wireless communication for implementing any of aspects 29 to 36.

Aspect 38 is an apparatus for wireless communication including means for implementing any of aspects 29 to 36.

Aspect 39 is a computer-readable medium storing computer executable code, where the code when executed by a processor causes the processor to implement any of aspects 29 to 36.

What is claimed is:

1. An apparatus for wireless communication at a user equipment (UE), comprising:
a memory;
at least one transceiver; and
at least one processor communicatively connected to the memory and the at least one transceiver, the at least one processor configured to:
perform one or more positioning measurements based on a set of signals from at least one network node, wherein the one or more positioning measurements are associated with at least one of a location of the UE or a location of the at least one network node;
select a secret key for communication with the at least one network node based on the one or more positioning measurements; and
communicate with the at least one network node based on the secret key.

2. The apparatus of claim 1, wherein the at least one network node includes at least one transmission reception point (TRP), a base station or a component of the base station, at least one sidelink device, at least one second UE, or a combination thereof.

3. The apparatus of claim 1, wherein the set of signals includes positioning reference signals (PRSs), synchronization signal blocks (SSBs), channel state information-reference signals (CSI-RSs), demodulation reference signals (DMRSs), sidelink reference signals, or a combination thereof.

4. The apparatus of claim 1, wherein the at least one processor is further configured to:
receive the set of signals from the at least one network node, wherein the one or more positioning measurements are performed after receiving the set of signals.

5. The apparatus of claim 1, wherein the at least one processor is further configured to:
receive a configuration from a serving base station, a location server, or a location management function (LMF), wherein the configuration indicates one or more resources for the set of signals that are to be dedicated for selecting the secret key.

6. The apparatus of claim 1, wherein the one or more positioning measurements includes:
reference signal receiving power (RSRP),
path RSRP,
reference signal time difference (RSTD),
phase path measurements,
relative time of arrival (RTOA),
azimuth angle of arrival (AoA),
zenith angle of arrival (ZoA),
signal-to-interference plus noise ratio (SINR),
one or more quality metrics,
Doppler shift,
reception-transmission (Rx-Tx) time difference, or
a combination thereof.

7. The apparatus of claim 1, wherein to select the secret key for the communication with the at least one network node, the at least one processor is further configured to:
generate the secret key based on a key generation function.

8. The apparatus of claim 1, wherein to communicate with the at least one network node based on the secret key, the at least one processor is further configured to:
encrypt one or more channels based on the secret key prior to communicating with the at least one network node; and
transmit the one or more channels to the at least one network node after encrypting the one or more channels.

9. The apparatus of claim 8, wherein the one or more channels are used for extracting the secret key.

10. The apparatus of claim 1, wherein to communicate with the at least one network node based on the secret key, the at least one processor is further configured to:
receive the set of signals from the at least one network node based on the secret key; and
decrypt the set of signals after receiving the set of signals.

11. The apparatus of claim 1, wherein the one or more positioning measurements are further associated with an uncertainty margin, such that any secret keys selected within the uncertainty margin are a same secret key.

12. The apparatus of claim 1, wherein the at least one processor is further configured to:
exclude the one or more positioning measurements based on the set of signals if the set of signals are unable to be decrypted.

13. The apparatus of claim 1, wherein the selection of the secret key is independent of the at least one network node.

14. A method of wireless communication at a user equipment (UE), comprising:
performing one or more positioning measurements based on a set of signals from at least one network node, wherein the one or more positioning measurements are associated with at least one of a location of the UE or a location of the at least one network node;
selecting a secret key for communication with the at least one network node based on the one or more positioning measurements; and
communicating with the at least one network node based on the secret key.

15. An apparatus for wireless communication at a network entity, comprising:
a memory;
at least one transceiver; and
at least one processor communicatively connected to the memory and the at least one transceiver, the at least one processor configured to:
receive one or more positioning measurements based on a set of signals from at least one network node, wherein the one or more positioning measurements are associated with at least one of a location of a user equipment (UE) or a location of the at least one network node;
select a secret key for communication of the at least one network node based on the one or more positioning measurements; and
transmit an indication of the secret key to the at least one network node.

16. The apparatus of claim 15, wherein the network entity corresponds to a location server or a location management function (LMF), and the at least one network node includes at least one transmission reception point (TRP), a base station or a component of the base station, at least one sidelink device, at least one second UE, or a combination thereof.

17. The apparatus of claim 15, wherein the set of signals are sounding reference signals (SRSs).

18. The apparatus of claim 15, wherein the at least one processor is further configured to:
transmit a request for the one or more positioning measurements to the at least one network node.

19. The apparatus of claim 15, wherein the at least one processor is further configured to:
transmit a configuration to the UE, wherein the configuration indicates one or more resources for the set of signals that are to be dedicated for selecting the secret key by the UE.

20. The apparatus of claim 15, wherein the one or more positioning measurements includes:
reference signal receiving power (RSRP),
path RSRP,
reference signal time difference (RSTD),
phase path measurements,
relative time of arrival (RTOA),
azimuth angle of arrival (AoA),
zenith angle of arrival (ZoA),
signal to interference plus noise ratio (SINR),
one or more quality metrics,
Doppler shift,
reception-transmission (Rx-Tx) time difference, or
a combination thereof.

21. The apparatus of claim 15, wherein to select the secret key for the communication of the at least one network node, the at least one processor is further configured to:
generate the secret key based on a key generation function.

22. The apparatus of claim 15, wherein the one or more positioning measurements are further associated with an uncertainty margin, such that any secret keys selected within the uncertainty margin are a same secret key.

23. The apparatus of claim 15, wherein the selection of the secret key is independent of the UE.

24. An apparatus for wireless communication at a first network node, comprising:
a memory;
at least one transceiver; and
at least one processor communicatively connected to the memory and the at least one transceiver, the at least one processor configured to:
configure at least one parameter for transmitting a set of signals;
select a secret key for communication with a second network node based on the at least one parameter; and
transmit the set of signals to the second network node based on the at least one parameter and the secret key.

25. The apparatus of claim 24, wherein the first network node corresponds to a user equipment (UE) and the second network node corresponds to at least one base station.

26. The apparatus of claim 25, wherein the at least one processor is further configured to:
transmit a request to a location server or a location management function (LMF), wherein the request specifies a positioning measurement-based secret key extraction.

27. The apparatus of claim 24, wherein the first network node corresponds to at least one base station and the second network node corresponds to a user equipment (UE).

28. The apparatus of claim 27, wherein the at least one processor is further configured to:
receive the at least one parameter from a location server or a location management function (LMF).

29. The apparatus of claim 27, wherein the at least one processor is further configured to:
perform one or more positioning measurements for a second set of signals from the second network node;
report the one or more positioning measurements to a location server or a location management function (LMF); and
receive an indication of the secret key from the location server or the LMF.

30. The apparatus of claim 24, wherein the set of signals include sounding reference signals (SRSs), positioning reference signals (PRSs), synchronization signal blocks (SSBs), channel state information-reference signals (CSI-RSs), demodulation reference signals (DMRSs), sidelink reference signals, or a combination thereof, and wherein the at least one parameter includes an angle of departures (AoD) for each of the set of signals.
